(19) United States
(12) Patent Application Publication
(10) Pub. No.: US 2024/0296356 A1
(43) Pub. Date: Sep. 5, 2024

(54) UNIVERSAL ASSESSMENT SYSTEM

(71) Applicant: KPMG LLP, New York, NY (US)

(72) Inventors: John A. Yanosy, JR., Grapevine, TX (US); Anu Puvvada, Houston, TX (US); Stephanie Kim, New York, NY (US); Andrew Urban, New York, NY (US)

(21) Appl. No.: 18/116,176

(22) Filed: Mar. 1, 2023

(51) Int. Cl. G06N 5/046; G06N 5/02

(52) U.S. Cl. CPC G06N 5/046; G06N 5/02

(57) ABSTRACT

An assessment theory model is contemplated that provides objective and high-quality assessments for assessment objects provided in some environment context. The assessment theory model provides a semantic and logical knowledge framework that may be used to design any assessment model for any kind of assessment object or environment contexts. The assessment theory model may help identify causal relationships between characteristics of the assessment object and the environment context. The assessment theory model guides the creation and definition of more specific models by helping to define the understanding of what should be considered in an assessment and guides the determination of the scope and focus of questions. The assessment theory model may permit or require provision of evidence and/or rationales in support of answers to promote objectivity and reduce bias. Scoring may be conducted in a manner that reduces bias so that more accurate decisions may be made based on scoring.

### FIELD OF THE INVENTION

Embodiments of the present invention relate generally to an assessment theory model and, in particular, to a universal assessment theory model that can be refined for a specific assessment object being assessed.

### BACKGROUND OF THE INVENTION

Current assessments ignore context and the causal influential relationships between intrinsic characteristics of an assessment object and the extrinsic characteristics of an external environment. Current assessments do not specify the semantics of its core concepts, specify any logical relationships in a model, or impose any requirements for data driven evidence-based objectivity. Thus, the determinations made by current assessment models tend to have lower accuracies.

Furthermore, the intrinsic characteristics of an object are at best subjective assessments relying on experts (or even non-experts) to examine their experiences and to make inferences based on their experiences. Often times, there is not specific information provided to enable a judgement of the trustworthiness of the response. Thus, these approaches have a high risk of subjectivity and low trustworthiness of the responses. Any weighting or scoring system cannot resolve such difficulties, since there is no way to identify those responses that are based on some evidence and those that were not.

There is a need for a theory to transform subjective assessments into objective assessments that account for the context of an assessment and help define what should be assessed in this context, and how the causal effects of an assessment object's intrinsic characteristics affect or are affected by the environmental context.

### BRIEF SUMMARY OF THE INVENTION

Various embodiments described herein provide an assessment theory model for use in making assessments of certain assessment objects, with the assessment object being provided in some environment context. The assessment theory model can provide a semantic and logical knowledge framework that can be used to design any assessment model for any kind of assessment object, for a wide variety of environment contexts, and with any number of extrinsic characteristics. The assessment theory model can help identify causal relationships between the intrinsic characteristics of the assessment object and the environment context.

The assessment theory model guides the creation and definition of more specific models by helping to define the understanding of what should be considered in an assessment. The assessment theory model also helps to ensure that the assessment takes into account environmental context for the assessment object being assessed as well as the potential categories for the assessment object. The assessment theory model also guides the determination of the scope and focus of the questions, which can be defined to solicit responses that will illuminate or clarify the intrinsic characteristics of the assessment object in each environmental context.

In addition, the assessment theory model can support objectivity and high-quality assessments. The assessment theory model can permit or require evidence and/or rationales in support of answers. Further, the assessment theory model can require that necessary objective evidence be provided to support the rationale for each response. The semantics of the core concepts of the assessment theory model are defined as having a specific role and meaning in the overall model as well as a set of relationships between them that form the logical ontological model, and the logical model can be defined with model level axioms in an ontology.

In some embodiments, methods and approaches for scoring responses can be provided. These methods can provide base scores based on the particular response, and various factors can be used to provide a weighted score that is adjusted up or down from the base score. Factors that can be used include an importance factor, a trustworthiness factor, and a certainty factor. Using the factors, weighted scores can be provided for each response. Additionally or alternatively, weighted scores can be provided for certain intermediary decisions (e.g. total risk level, opportunity level, etc.) or to provide an overall score so that a final decision can be made. Through the use of the scoring approaches, scoring can be conducted in a manner that reduces or completely eliminates bias so that more accurate decisions can be made based on the scoring.

Various screens can be presented to respondents in a display, and the screens can elicit responses from the respondents and/or present information about the assessment to the respondent. The screens can prompt users to provide responses, which can include a specific answer, a supporting rationale, and supporting evidence. As more and more responses are received, the information about the assessment can be further refined. Screens can present various metric information to the user, and this metric information can include a final decision, intermediate decisions (e.g. risk level, opportunity level, etc.), or more specific information. In some embodiments, screens can present information about a specific characteristic. Metric information can be presented to the user in an easily understandable manner, with metric information indicating whether a certain assessment value response is high, medium, or low in value. The screens can be generated by a user interface generator.

In some embodiments, an exemplary innovation assessment knowledge system can be provided. This system can have a designed architecture that defines and semantically integrates logical and computational models to transform subjective assessments into objective assessments. The system can be defined with multiple ontologies representing specific and universal assessment model knowledge. Additionally, ontologies enable flexible definitions of multiple models to be provided for interpreting assessment responses with different scoring models, categories, questions, etc. In some embodiments, models can adapt the assessment model as responses are received (e.g., to better focus on areas of uncertainty, etc.). The system can include innovation taxonomy concepts organized as assessment categories, assessment types, and weighting factor concepts to represent levels of certainty and importance, defined default answers for each question with base score contribution value for answers to each question, and various assessment phase modules for organizing sequential assessment phases and relevant questions and categories. The system can also include an assessment classification and scoring model that represents the impact of each question to an overall assessment as well as the question's scoring impact by category and assessment phase. The system can also include a decision classification system (e.g. perish, pivot, or persevere) that is objectively determined by the survey response scoring model and the categories and questions relevant to that phase of the assessment. Various embodiments of the system beneficially enable objective decision classifications using semantic, logical, and quantitative reasoning, where the categories, environment context, questions, default answers and decision phases are defined semantically by the system ontologies. The logical definitions can organize the semantic concepts just mentioned by relationships defined in the ontology, while quantitative reasoning can be enabled by the base score values assigned to each question's set of default answers and a set of ontology inferential reasoning and knowledge queries to aggregate the assessment score by question, category, phase, and total for previously defined decision classifications. The system can include definitions for categories with specific questions defined to illuminate the innovation characteristics effects from different perspectives. Categories also have specific questions defined to explore the nature of the intrinsic or extrinsic category. Questions can be provided with default answers that the user can select from, and default answers can have a base score (e.g. in the range of −5 to +5). Weighted scores can be generated based on answers, evidence, and rationales provided in response to questions, with the weighted scores being adjusted based on trustworthiness of responses, uncertainty in the responses, and/or importance in the responses.

In an example embodiment, a system capable of making an assessment of an assessment object is provided. The system comprises an inquiry module configured to generate questions, a user interface module configured to receive from a user responses to the questions, a scoring module configured to generate a score based on the responses from the user, and a decision module that generates the assessment based on the score and the responses. Additionally, in some embodiments, the system can also comprise a relationship module configured to identify a causal relationship between an extrinsic characteristic of an environment context and an intrinsic characteristic of the assessment object, and the decision module can be configured to make the assessment based on the causal relationship.

In some embodiments, the system can be capable of making assessments of different assessment object types within one or more influencing environments. The system can have one or more defined assessment models defining sets of questions for a defined assessment object and extrinsic characteristics, and each defined assessment model of the defined assessment model(s) can have one or more scoring models. Furthermore, in some embodiments, the inquiry module can be configured to generate a refined question based on a previous response.

In some embodiments, the scoring module can comprise a base scoring module that is configured to generate a base score for at least one response of the responses, one or more additional modules that are configured to provide one or more scoring adjustments to the base score for the response(s), and a weighted scoring module that generates the score for the response(s) based on the base score and the scoring adjustment(s). The decision module can make the assessment based on the score. Additionally, in some embodiments, the additional module(s) can include an importance module, and the importance module can be configured to provide an importance level scoring adjustment based on an importance level of the response(s). In some embodiments, the additional module(s) can include a trustworthiness module. The trustworthiness module can be configured to provide a trustworthiness scoring adjustment based on a trustworthiness of the response(s), and the trustworthiness scoring adjustment can be impacted by at least one of a detected bias in the response(s), consistency with an additional response, or inconsistency with the additional response. Furthermore, in some embodiments, the additional module(s) can include a certainty module, and the certainty module can be configured to provide a certainty scoring adjustment based on an uncertainty level of the response(s). Additionally, the response(s) can include an answer, a rationale in support of the answer, and evidence in support of at least one of the answer or the rationale, and the additional module(s) can be configured to provide one or more scoring adjustments to the base score for the response(s) based on the rationale and the evidence.

In some embodiments, the system can also comprise an assessment knowledge module that stores one or more ontologies, a knowledge base query module that is configured to load material for use in the assessment, and an extraction module that receives the responses and extracts relevant answers, rationales, and evidence from the responses. Furthermore, in some embodiments, the one or more ontologies can include an assessment theory ontology, a question survey ontology, a journey ontology, a decision ontology, a decision gate ontology, and an assessment analysis ontology.

In some embodiments, the system can also include a display, the system can be configured to cause the presentation of questions on the display, and the system can be configured to present metric information with a final decision or an intermediate decision of the assessment. Additionally, in some embodiments, the system can also comprise an improvement module that assesses a potential task that improves the score, and the improvement module can cause presentation of the potential task on a display.

In some embodiments, the system also includes a machine learning module that uses machine learning to carry out other tasks. The machine learning module can be configured to receive one or more data points, create a model that is configured to generate a model predicted output, minimize error between the model predicted output and an actual output for the one or more data points, calculate an error rate between the model predicted output and the actual output for the one or more data points, determine whether the error rate is sufficiently low, receive additional data points upon a determination that the error rate is sufficiently low, provide a predicted output data value for the additional data points using the model upon a determination that the error rate is sufficiently low, and modify the model based on the supplemental data points upon a determination that the error rate is sufficiently low.

In some embodiments, the system also includes a scoring module that generates a weighted score for the assessment. The scoring module can be configured to receive at least one response from a user, determine a base score for the response(s), determine at least one scoring adjustment based on at least one additional factor, and determine the weighted score for the response using the base score and the scoring adjustment(s).

In another example embodiment, a method capable of making an assessment of an assessment object is provided. The method comprises receiving at least one response, determining a base score for the response(s), determining at least one scoring adjustment based on at least one additional factor, determining a weighted score for the response(s) using the base score and the scoring adjustment(s), and making the assessment based on the weighted score. In some embodiments, the scoring adjustment(s) can include an importance level scoring adjustment based on an importance level of the response. Additionally, in some embodiments, the scoring adjustment(s) can include a trustworthiness scoring adjustment based on a trustworthiness of the response(s), and the trustworthiness scoring adjustment can be impacted by at least one of a detected bias in the response(s), consistency with an additional response, or inconsistency with the additional response. Furthermore, in some embodiments, the scoring adjustment(s) can include a certainty scoring adjustment based on an uncertainty level of the response.

In another example embodiment, a non-transitory computer readable medium is provided having stored thereon software instructions that, when executed by a processor, cause the processor to receive at least one response, determine a base score for the response(s), determine at least one scoring adjustment based on at least one additional factor, determine a weighted score for the response(s) using the base score and the scoring adjustment(s), and make an assessment based on the weighted score. In some embodiments, the scoring adjustment(s) can include an importance level scoring adjustment based on an importance level of the response. Additionally, in some embodiments, the scoring adjustment(s) can include a trustworthiness scoring adjustment based on a trustworthiness of the response(s), and the trustworthiness scoring adjustment can be impacted by at least one of a detected bias in the response(s), consistency with an additional response, or inconsistency with the additional response. Furthermore, in some embodiments, the scoring adjustment(s) include a certainty scoring adjustment based on an uncertainty level of the response.

In another example embodiment, a system for making an assessment of an assessment object is provided. The system comprises a processor and memory. The memory has stored thereon software instructions that, when executed by a processor, cause the processor to receive at least one response, determine a base score for the response(s), determine at least one scoring adjustment based on at least one additional factor, determine a weighted score for the response(s) using the base score and the scoring adjustment(s), and make an assessment based on the weighted score. In some embodiments, the scoring adjustment(s) include an importance level scoring adjustment based on an importance level of the response. Additionally, in some embodiments, the scoring adjustment(s) include a trustworthiness scoring adjustment based on a trustworthiness of the response(s), wherein the trustworthiness scoring adjustment is impacted by at least one of a detected bias in the response(s), consistency with an additional response, or inconsistency with the additional response. In some embodiments, the scoring adjustment(s) include a certainty scoring adjustment based on an uncertainty level of the response.

### BRIEF DESCRIPTION OF THE DRAWINGS

Having thus described the invention in general terms, reference will now be made to the accompanying drawings, which are not necessarily drawn to scale, and wherein:

FIGS. 1A-1B are schematic diagrams illustrating an innovation product assessment system, in accordance with some embodiments discussed herein;

FIG. 2 is a schematic diagram illustrating an exemplary scoring module and various modules provided therein, in accordance with some embodiments discussed herein;

FIG. 3 is a schematic diagram illustrating an example assessment theory model for assessing an assessment object, in accordance with some embodiments discussed herein;

FIG. 4 is a schematic diagram illustrating exemplary modules that can be included in processing circuitry in some environment context, in accordance with some embodiments discussed herein;

FIG. 5A-5B are schematic diagrams illustrating example ontology class diagrams with associations between different characteristics, in accordance with some embodiments discussed herein;

FIG. 6A-6C are schematic views illustrating example screens that can be presented on a display, in accordance with some embodiments discussed herein;

FIG. 7 is a flow chart illustrating an example method for making universal assessments, in accordance with some embodiments discussed herein;

FIG. 8 is a flow chart illustrating an example method for scoring, in accordance with some embodiments discussed herein;

FIG. 9 is a flow chart illustrating an example method of machine learning that can be utilized in making universal assessments, in accordance with some embodiments discussed herein;

FIG. 10 is a schematic view illustrating an exemplary architecture of the processing circuitry 1000, in accordance with some embodiments discussed herein;

FIG. 11 is a flow chart illustrating an example method for defining assessment models, in accordance with some embodiments discussed herein;

FIG. 12 is a flow chart illustrating an example method for assessment execution and selection of what defining models to apply to the assessment, in accordance with some embodiments discussed herein; and

FIG. 13 is a flow chart illustrating an example method with operations to create a scoring model for a related assessment model, in accordance with some embodiments discussed herein.

### DETAILED DESCRIPTION

Example embodiments of the present invention now will be described more fully hereinafter with reference to the accompanying drawings, in which some, but not all embodiments of the invention are shown. Indeed, the invention can be embodied in many different forms and should not be construed as limited to the example embodiments set forth herein; rather, these embodiments are provided so that this disclosure will satisfy applicable legal requirements. Additionally, any connections or attachments can be direct or indirect connections or attachments unless specifically noted otherwise.

As used herein, a response is intended to include an answer, rationale provided in support of that answer, and evidence provided in support of the answer and/or the rationale. Furthermore, independent intrinsic characteristics are those characteristics of the assessment object that are inherent to the assessment object and that are not affected by other characteristics. Dependent intrinsic characteristics are those characteristics of the assessment object that are affected by a relationship with other characteristics. Additionally, extrinsic characteristics are characteristics of the environment context that the assessment object is in.

As used herein, the term “machine learning” is intended to mean the application of one or more software application techniques or models that process and analyze data to draw inferences and/or predictions from patterns in the data. The machine learning techniques can include a variety of models or algorithms, including supervised learning techniques, unsupervised learning techniques, reinforcement learning techniques, knowledge-based learning techniques, natural-language-based learning techniques such as natural language generation, natural language processing (NLP) and named entity recognition (NER), deep learning techniques, and the like. The machine learning techniques are trained using training data. The training data is used to modify and fine-tune any weights associated with the machine learning models, as well as record ground truth for where correct answers can be found within the data. As such, the better the training data, the more accurate and effective the machine learning model.

As used herein, the term “trustworthiness” is intended to mean the ability to be relied upon as being honest or truthful. As used herein, the term “certainty” is intended to mean a quality of being reliably true. As used herein, the term “uncertainty” is intended to mean a quality of not being reliably true.

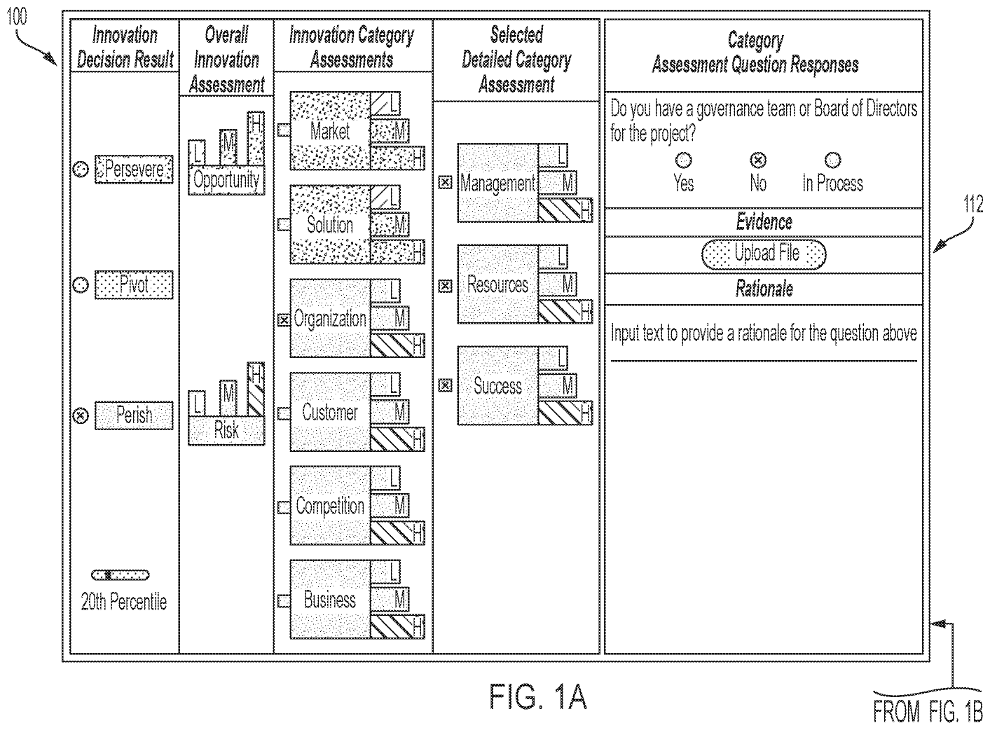

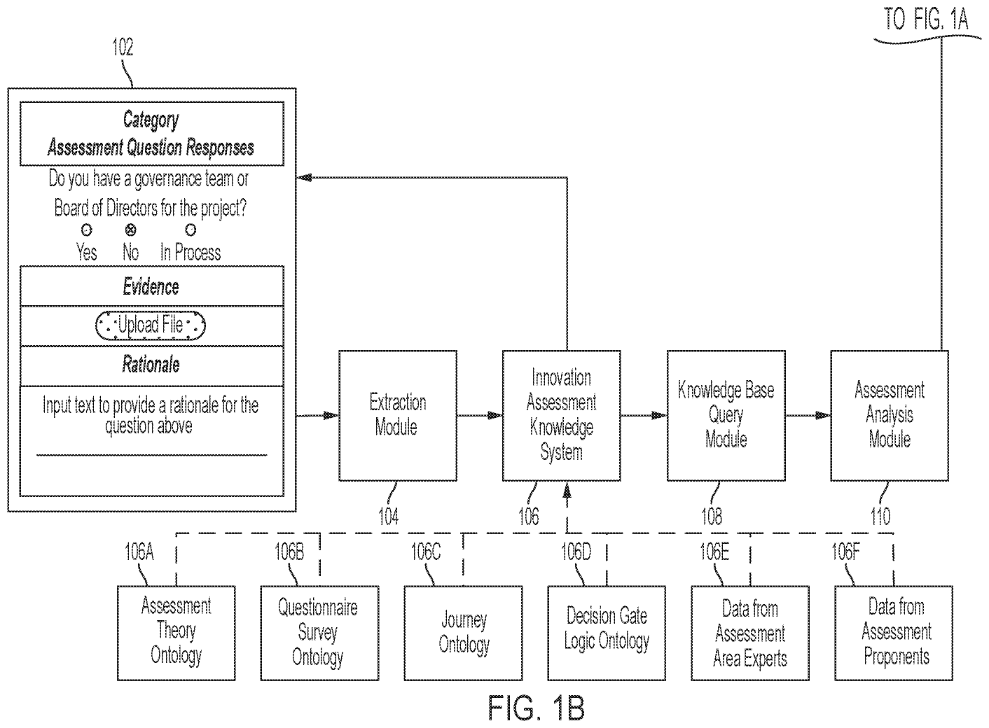

FIGS. 1A-1B are schematic diagrams illustrating an innovation product assessment system 100. A questionnaire 102 can be provided to users to elicit responses to various questions. In the response, the user can provide an answer to a specific question, a rationale in support of the answer, and evidence to support the answer and/or the rationale. A dedicated module (e.g., a questionnaire module having a questionnaire ontology 106B provided thereon) can be used to provide the questionnaire 102 in some embodiments.

An extraction module 104 can receive the responses that were input by the user, and the extraction module 104 can extract the relevant answers, rationales, and evidence. The extraction module 104 can also transform the answers, rationales, and evidence into an appropriate data format so that this information can be easily asserted as facts in the innovation assessment knowledge system 106, which can semantically represent these asserted facts in the form of the data from assessment area experts 106E or data from assessment proponents 106F from the questionnaire 102 by the questionnaire survey ontology 106B. Information can be interpreted using an assessment theory ontology 106A, the journey ontology 106C, a category ontology, and the decision gate logic ontology 106D. The extraction module can load the answers, rationales, and evidence into innovation assessment knowledge system 106.

The innovation assessment knowledge system 106 can receive various inputs. These inputs can include data from assessment area experts 106E and data from assessment proponents 106F in some embodiments. This data can also be represented as answers to questions defined by the questionnaire survey ontology 106B. Additionally, the innovation assessment knowledge system 106 includes multiple interrelated ontologies to semantically represent the assessment models including the questions and their default answers 106B. The ontologies assist in the semantic interpretation of features as intrinsic and extrinsic characteristics in the assessment theory ontology 106A, and the questions and their assessment journey phase can be categorized in the journey ontology 106C. For example, the innovation assessment knowledge system 106 can include an assessment theory ontology 106A, a questionnaire survey ontology 106B, a journey ontology 106C, and a decision gate logic ontology 106D, and an assessment analysis ontology on the assessment analysis module 110. However, in other embodiments, other ontologies and other inputs can be provided at the innovation assessment knowledge system 106.

The innovation assessment knowledge system 106 can be configured to make assessments based on the responses provided by users. The innovation assessment knowledge system 106 beneficially makes incremental assessments that improve the accuracy of the decisions at different phases. Additionally, as further knowledge is obtained about an assessment object, the innovation assessment knowledge system 106 beneficially refines questions presented to users. Thus, the questions can be more refined to target particular aspects of the assessment categories that illuminate the extrinsic and intrinsic characteristics of the assessment object, allowing for better decisions to be made.

Data from the innovation assessment knowledge system 106 can be accessible to a knowledge base query module 108. The knowledge base query module 108 can be configured to perform SPARQL queries in some embodiments, which are pre-defined to provide fine granular analysis at the question/response level, to enable the analysis defined by the assessment analysis ontology of the assessment analysis module 110. The knowledge base query module 108 can be configured to load material from the innovation assessment knowledge system 106 into an appropriate data format so that this material can be easily utilized alongside other data at the assessment analysis module 110. In some embodiments, the queries can additionally or alternatively be stored in the innovation assessment knowledge system 106 for subsequent use in accessing the stored facts for one or more assessments of an innovation object.

The assessment analysis module 110 can analyze data available to provide an assessment output 112. The assessment output 112 is exemplary in nature, and other formats and interactions can be utilized to present the results of the assessment. These results can be final results of an assessment, or alternatively, the assessment output 112 can be intermediary results of an assessment that are presented, and the assessment output 112 can be refined further as additional responses to the questionnaire 102 are received from the user. One beneficial assessment knowledge enabler is the combined hierarchical semantic representation assessment by question-answer, category, journey phase, with the quantitative analysis scoring contained and summarized level of abstraction, including adjustments made to remove bias and to accurately represent the trustworthiness and certainty of the responses.

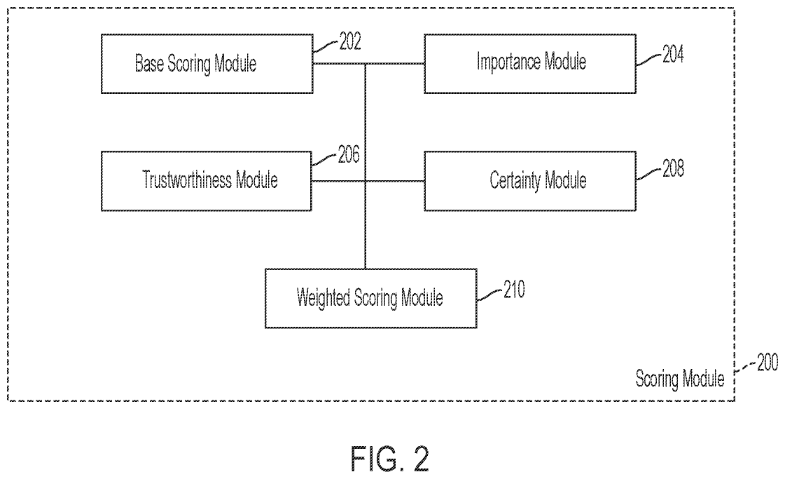

FIG. 2 is a schematic diagram illustrating an exemplary scoring module 200 and various modules provided therein. This scoring module 200 can be provided as part of the innovation product assessment system 100 of FIG. 1 (e.g., as the assessment analysis module 110 or a component thereof). The scoring module 200 can receive data from the knowledge base query module 108 of FIG. 1 about responses from one or more respondents and the question and data stored in the innovation assessment knowledge system 106 for the purpose of analyzing that data to develop a score per response. The scoring module 200 can have one or more modules therein that assist in adjusting scores. For example, the scoring module 200 can include an importance module 204, a trustworthiness module 206, and a certainty module 208 that modify the question/response scores for its default answers as initially defined in the base scoring module 202. In some embodiments, the effect of the adjustment score for each question default answer is predefined if specific assessment response conditions are satisfied. In other embodiments, some of the adjustment factors can be more dynamic and can depend on the response conditions and other responses. For example, the importance factor defined in the importance module 204 is predefined and its weighted impact affects all assessment responses as a static factor applied to each question. The trustworthiness factor can be more dynamic in that its adjustment depends on the type of respondent, so the score may or may not be adjusted based on the type of respondent. Even here, the adjustment scores can be predefined for all types of respondents and stored in the innovation assessment knowledge system 106. The scoring module 200 can evaluate answers that are provided by the respondent to specific questions, and the scoring module 200 can also assess any supporting rationales that are provided to support the answers of a respondent. For example, in evaluating supporting rationales, the scoring module 200 can simply identify whether any supporting rationale is provided in determining an appropriate adjustment to the score. However, in other embodiments, a more detailed analysis of the supporting rationale can be conducted.

In some embodiments, various data points can be adjusted in weighting to make some data points have more relevance and to make other data points have less relevance. For example, answers to questions, external data, and data from other respondents (which can be aggregated and/or anonymized) can assist in performing this weighting. In some embodiments, the effect of the adjusted scoring weights can incrementally impact the assessment scores as various questions are responded to and as more data is obtained.

The scoring module 200 can evaluate trustworthiness of response and/or bias of a response with a trustworthiness module 206, and this can, for example, be accomplished by assessing the trustworthiness of the responder providing the information. The trustworthiness module 206 can evaluate inconsistencies between responses and reduce weight of responses to the extent there are inconsistencies. There can be defined different categories of responders with different adjustment factors for different categories of questions. For example, an innovation proponent can be biased as to the potential commercial success potential of the innovation, which would indicate that answers to questions related to innovation commercial success potential should be adjusted accordingly to have less impact on the overall score. The trustworthiness module 206 can identify irreconcilable contradictions in the answers, evidence, and/or rationales and can also identify instances where the answers, evidence, and/or rationales are consistent, and the trustworthiness module 206 can provide adjustments to the scoring accordingly.

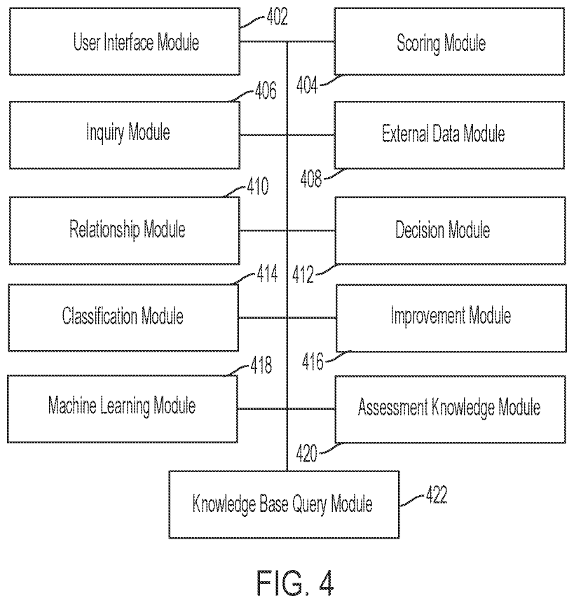

In some embodiments, the inquiry module 406 (see FIG. 4) can be configured to craft and present redundant questions to the respondent. Slight differences in wording can be present in the redundant questions. The trustworthiness module 206 can assess the consistency or inconsistency in the answers, evidence, and rationales provided in response to redundant questions and adjust the scoring accordingly. However, in other embodiments, the inquiry module 406 can be configured to minimize or eliminate redundant questions.

Objectivity is an important design characteristic for assessment models. Objectivity can be improved by requiring that an explanatory rationale be provided in support of some or all of the answers and by requiring that objective evidence be provided in support of some or all of the answers and/or rationales. This immediately provides a basis for rating the trustworthiness of the response to a question and its use in assessment logical decisions. The scoring module 200 or the trustworthiness module 206 therein can assess the rationale and any objective evidence provided and can make appropriate adjustments to the score based on the rationale and objective evidence. Different types of evidence often have different levels of truthfulness or risks of use. Assessments of the truthfulness, risks of use, and/or benefits of use can be made using algorithms, or these assessments can be made using machine learning and/or artificial intelligence. In some embodiments, the scoring module 200 can simply look to see if any rationale and/or objective evidence is provided in support and make scoring adjustments based on the presence or absence of this information, but the scoring module 200 can be used to more thoroughly evaluate the provided information to determine an appropriate score.

The scoring module 200 can be configured to provide various scoring adjustments based on the answers, evidence, and rationales provided by the respondent. For each response, a base scoring module 202 is configured to provide a base score. The base score can be a score ranging from −5 to +5, a score ranging from −5 to 0, or a score ranging from 0 to +5, with the relevant scoring range being provided based on questions asked. For example, where a question is directed towards risks for a given assessment object, then the score range of −5 to 0 can be appropriate, and where a question is directed towards the opportunities provided by an assessment object, then the score range of 0 to +5 can be appropriate. However, a wide variety of other scoring ranges can be utilized. Each question's possible default answer within the set of default answers can be assigned a score within the question's answer range (e.g., −5 to 0, 0 to +5, −5 to +5). For a specific assessment by a responder, each question's answer is assigned the relevant score value from this predefined score value for this answer.

Additionally, various factors can be used to assist in making scoring determinations in the scoring module 200. These factors can be assessed at dedicated modules within the scoring module 200, with each of the dedicated modules assessing the factors and providing an appropriate score adjustment based on the impact of the factor. In the illustrated embodiment of FIG. 2, an importance module 204, a trustworthiness module 206, and a certainty module 208 are provided. However, other modules can be provided within the scoring module 200 in other embodiments where additional factors are considered in scoring determinations.

Each adjustment factor can be applied to the base scores for each default answer to each question in such a manner that the relative impact of a question's score is modified with respect to the impact of all other questions, thus leaving the minimum and maximum values for the total possible base score for all questions the same. What is adjusted is the relative impact of the response to the overall assessment score. In this way, the factor's impact on the score is adjusted instead of the score ranges. Multiple factors can be defined as illustrated in the exemplary set of adjustment factors as shown in FIG. 2.

An importance factor can be assessed at the importance module 204. This importance factor can be dependent upon the importance of certain questions, and this weight can, for example, be an integer weighed from 1 to 10. Increasing the weight of one response can effectively reduce the weight of another response. Importance can be determined based on input from subject matter experts, based on information obtained from other users, or using other approaches. Additionally, the importance can be higher or lower for a given question based on the strength of a relationship between a characteristic of an assessment object with some other characteristic (e.g., an extrinsic characteristic of the environmental context or another intrinsic characteristic of the assessment object).

In some embodiments, a trustworthiness factor can be assessed at a trustworthiness module 206. The focus of the trustworthiness factor is the level of trust associated with a particular type of respondent, where various biases can be associated with a respondent that cause high or low assessment scores for an assessment object. For example, an inventor of a particular innovation can respond with a more positive bias for commercial success of that innovation than a responder without a stake in the innovation. To some extent, this can be remediated by the rationale and evidence to support a specific answer, and the trustworthiness factor will not affect the score where this is the case in some embodiments. Where there is no rationale or evidence, the trustworthiness factor can affect the response score. The trustworthiness module 206 can assess appropriate scoring adjustments where the answers, evidence, and/or rationales provided in response to the question are inconsistent with answers, evidence, and/or rationales provided in response to another question. The trustworthiness module 206 can also provide appropriate scoring adjustments associated with a particular question downwardly where answers, evidence, and/or rationales indicate some bias in how the respondent is answering the questions. Biases can be detected by analysis of a single answer, a single piece of evidence, and/or just one rationale. Alternatively, biases can be detected by analysis of patterns in multiple answers, pieces of evidence, and/or rationales. Trustworthiness, consistency, and biases can be identified through the use of machine learning, artificial intelligence, or man-made algorithms or by predefined responder types, which have the potential for bias. Where responses are consistent and/or there is no bias detected, the trustworthiness module 206 can adjust the score associated with a particular question upwardly in some embodiments.

In some embodiments, the determination can be weaker where there is inherent uncertainty regarding some aspects of the assessment. The certainty module 208 can be included in the scoring module 200 to account for uncertainty in responses. Where limited information is available regarding a certain question, a certainty factor provided by the certainty module 208 can be reduced to effectively adjust the score downwardly for the given question. In some embodiments, where the information available for a certain characteristic of an assessment object is relatively high, the certainty module 208 can increase the certainty factor so that the score is improved due to the increased certainty. In some embodiments, the limited information can be based on the lack of supporting evidence and/or supporting rationales. Certainty initially can be categorized by two classes of questions, factual questions and judgement or estimation questions. Factual questions can have a high certainty as responses should be based on facts with evidence, while judgement or estimation questions can have an inherent uncertainty due to the possible subjective nature relying on the judgement of a respondent or an uncertainty due to the need to predict based on estimation. Even here, the certainty module can initially apply an adjustment based on the class ((i) factual or (ii) judgement/estimation questions) and store the adjustments in the innovation assessment knowledge system 106. In some embodiments, the certainty module 208 can account for rationale and evidence and modify the negative or positive effect of the certainty factor. The certainty or uncertainty can be directly related to the nature of the information necessary to enable a response. Questions designed to elicit a response that is based on knowledge of objective facts can have a more certain scoring value than a question designed to elicit a response relying on estimates or judgement.

The scoring module 200 also includes a weighted scoring module 210. A weighted score can be determined at the weighted scoring module 210 using the base score provided by the base scoring module 202 and one or more of the factors from the other modules. In some embodiments, the base score and the various factors being used (e.g. the importance factor, the trustworthiness factor, the certainty factor) can be multiplied or added together at the weighted scoring module 210 to get a weighted score for the question. In some embodiments, a cross-product can be used to get the cumulative impact of the various responses. However, the weighted scores can be obtained in other ways. Through the scoring approach taken by the scoring module 200, an objective score can be obtained to provide increased accuracy in assessments. Examples of various modules within the scoring module 200 and potential scoring adjustments are provided here, but various other modules and scoring adjustments can be utilized. Some adjustments can remove bias and transform a subjective assessment into an objective assessment that is not easily gamed by assessment responders.

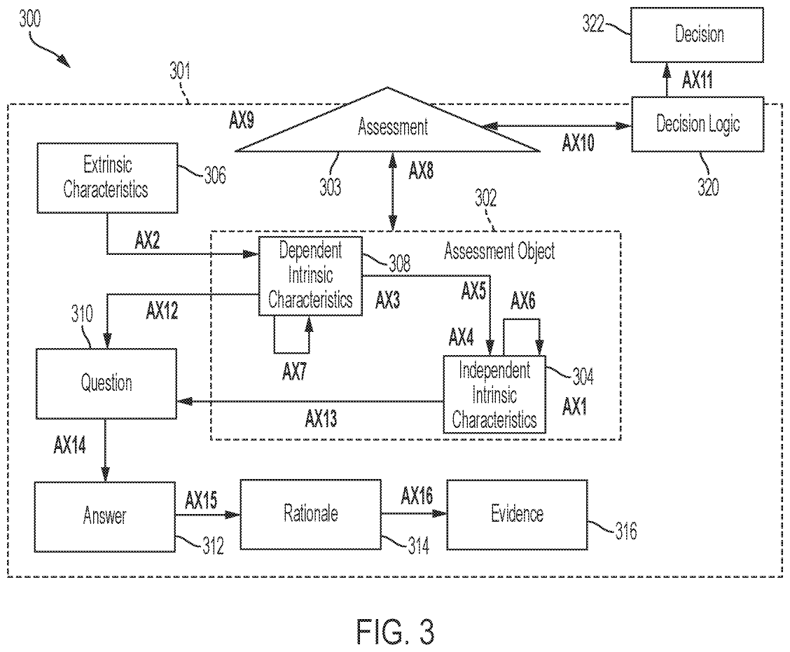

FIG. 3 is a schematic diagram illustrating an example assessment theory model 300 for assessing an assessment object 302. The assessment theory model 300 can be utilized by the innovation assessment knowledge system 106 of FIG. 1. For example, the assessment theory model 300 can serve as the assessment theory ontology 106A of FIG. 1 or as a portion of the assessment theory ontology 106A. The assessment theory model 300 is based on the concept that any assessment is focused on understanding or evaluating an assessment object 302 within some environmental context. The assessment theory model 300 can provide a logical model framework with specified logical necessary conditions to ensure that any assessment made using the assessment theory model 300 is semantically and logically valid. The assessment theory model 300 can accomplish this by including defined semantics for core model concepts, logical axioms, and required conditions for a specific assessment model definition to satisfy. One beneficial aspect of the assessment theory model 300 is that the model can be capable of identifying relationships between different properties, such as the relationship between dependent intrinsic characteristics 308 of an assessment object 302 and the extrinsic characteristics 306.

The assessment theory model 300 can be “universal” in that it is capable of being adapted to a wide variety of assessment objects 302 and to a wide variety of different environmental contexts and extrinsic characteristics 306, and with a variety of different defined assessments 303. For example, in assessing a potential business that can be acquired, the assessment theory model 300 can be used to determine whether or not the business is a good investment opportunity. In such a scenario, the assessment object 302 can be the particular business as well as some innovation object, and independent intrinsic characteristics 304 can include features related to the uniqueness of the business such as proprietary advantages in the form of intellectual property, proprietary processes, and object differentiation, and other independent intrinsic characteristics 304, while the innovation object can include such independent intrinsic characteristics as product cost, which would affect the financial expenses for the business with respect to a product offering. Other extrinsic characteristics 306 can include the market environment and revenue and profit margins in the relevant field. Extrinsic characteristics 306 can also include the supply chain environment and the available suppliers, logistics, available partnerships, stability, and competitive risk in the relevant field.

The assessment theory model 300 can also be used to evaluate potential product ideas that have been conceptualized, to assess the readiness of a business idea to evaluate whether that business idea is ready to be implemented, or in other ways. As another example, the assessment theory model 300 can be used to determine whether one should consider building a product internally or buying the product from another external supplier or manufacturer.

In the context of the decision to build or buy, various factors can be appropriate. For example, various factors that can be relevant in the decision to buy can include the quantities that are involved, whether drawings need modification, whether the product falls within the company's core competencies, whether demand will be temporary or permanent, whether demand will likely fluctuate, whether special manufacturing techniques or equipment are required, whether there are issues of maintaining secrecy, the likely markets for the product, the degree of design changes that will be necessary, the difficulty of quality control, the ability to obtain and retain production personnel, transportation expenses, whether relevant intellectual property would serve as a potential barrier to entry, the relevant amount of royalties that would be required, pricing and quantities required for purchases, presence of specialized techniques for production, whether raw material is readily available or difficult to obtain, and taxes and other costs. While various factors are listed here, various other factors can be relevant to the build/buy decision.

In the assessment theory model 300, various classes are defined in a semantic model with definitions for each class and a defined set of relationships that are asserted between the classes. The assessment theory model 300 can be defined to assess a specific kind of assessment object 302 that is in an assessment operating environment 301.

Assessment characteristics are provided for the assessment object 302 in the assessment theory model 300. These assessment characteristics, take the form of categories with their associated unique questions that are either intrinsic to the assessment object or are extrinsic in some assessment operating environment 301 with some extrinsic characteristics 306, that have the objective of describing the relationship between the assessment object and the assessment characteristic. Each question is aligned within a category which is synonymous with the assessment characteristic semantics or meaning. An assessment object 302 can take a variety of forms. For example, the assessment object 302 can be a tax audit service or something simpler like an electric motor. The primary focus of the assessment theory model 300 is to evaluate some assessment object 302 of some type that is being assessed with the assessment characteristics defined in the assessment theory model 300, with the assessment characteristics being either independent intrinsic characteristics 304 or dependent intrinsic characteristics 308. The kind of assessment object 302 can be a product offered in the buy/sell market, a service offering to the market, a new manufacturing process, an innovative employment candidate selection process, a problem presented by a customer, etc. There is no constraint of the kind of assessment object 302 to be assessed, only that the assessment 303 should reflect those assessment contexts, independent intrinsic characteristics 304, extrinsic characteristics 306, and dependent intrinsic characteristics 308 relevant to the kind of object and the context.

In the assessment theory model 300 of FIG. 3, an assessment object 302 within a given assessment operating environment 301 is assessed. The assessment theory model 300 is beneficial in that it evaluates the relationships between various properties to identify causal dependencies that would not otherwise be identified by other approaches. Where simple approaches are taken, these causal dependencies will not be evaluated in some embodiments, leading to reduced accuracy in assessments. The assessment theory model 300 is beneficial as it can be used to form an assessment theory ontology (e.g., the assessment theory ontology 106A of FIG. 1), and the assessment theory model 300 can be implemented using W3C OWL2 ontology languages or some other ontology language.

The assessment operating environment 301 can have an environment context that represents the kind of assessment operating environment 301 that the assessment object 302 should be evaluated from. The environment context forms a prism in which extrinsic characteristics 306 of the context are selected that are affected by or that affect an assessment object 302. The environment context therefore has a defined set of extrinsic characteristics 306 that are selected to be relevant to an assessment of the assessment object 302. Extrinsic characteristics 306 are those characteristics of the environment context that are affected by or affect the assessment object 302. The selection of the extrinsic characteristics 306 should be specific to an environment context in which the assessment object 302 is being assessed. For any assessment of an assessment object 302, there might be multiple environment contexts that are relevant to the overall assessment of the assessment object 302. An example of an environment context could be a buy/sell product or service competitive market context, an organization context who owns the object, or a regulatory context, etc.

There are two different types of assessment characteristics for an assessment object 302, independent intrinsic characteristics 304 and dependent intrinsic characteristics 308. Independent intrinsic characteristics 304 are those characteristics of the assessment object 302 that are inherent to the assessment object 302 and that are not affected by other characteristics. Dependent intrinsic characteristics 308 are those characteristics of the assessment object 302 that are affected by a relationship with other characteristics. Dependent intrinsic characteristics 308 can be affected by extrinsic characteristics 306 of the environmental context that the assessment object 302 is in, or the dependent intrinsic characteristics 308 can be affected by other intrinsic characteristics. For example, as changes are made in certain extrinsic characteristics 306, there can be corresponding changes made in the dependent intrinsic characteristics 308 of the assessment object 302. The assessment theory model 300 recognizes and defines the ability to represent causal effects and dependency effects between dependent intrinsic characteristics 308, independent intrinsic characteristics 304, and extrinsic characteristics 306. The assessment theory model 300 also recognizes and defines the ability to represent causal effects and dependency effects between two or more different dependent intrinsic characteristics 308.

Furthermore, characteristics can be permanent or temporary, and the appropriate classification can depend on the specific assessment object, the environmental context, and other factors. For example, the mass of an object can be considered a permanent characteristic for some objects, but a temporary characteristic for other objects—the mass of an electric motor does not change with operation, while the mass of a living organism might change through the life of the organism due to a variety of causes. The mass is a permanent intrinsic characteristic for the electric motor, and the mass is a temporary characteristic that might change over time for the organism.

What can be considered to be an independent intrinsic characteristic 304 in some instances can be appropriately considered to be a dependent intrinsic characteristic 308 in other instances. The determination of the appropriate classification for a given characteristic can be made based on the assessment object 302 being assessed, the environmental context, and other factors.

Dependent intrinsic characteristics 308 are those characteristics of the assessment object 302 that are subject to change based on changes in other characteristics. Examples of dependent intrinsic characteristics 308 for a market context include estimated revenue and market share. The estimated revenue and market share are both items that are subject to changes based on other characteristics such as the amount of competition in a given field, the current economic situation, etc. Example of dependent intrinsic characteristics 308 for a manufacturing context could include manufacturing capacity and manufacturing yield—manufacturing capacity and manufacturing yield can be impacted by extrinsic characteristics 306 such as the availability or lack of availability for certain materials, the number of available workers, or other extrinsic characteristics 306. Additionally, examples of dependent intrinsic characteristics 308 for an organization might include available resources, geographic scope, management governance, and type of entity. As another simple example, the weight of an object can serve as a dependent intrinsic characteristic 308 the weight of the object can be dependent on the environmental context that the object is in because the gravitational force acting on the object can be different depending on whether or not the object is on Earth, in orbit, or on some other planet. For example, an object located on the moon has a lower weight compared to its weight on earth.

The possible values for a characteristic are dependent on the nature of the environment context, the assessment object 302, and/or the understood range of values that are used to value the characteristic state itself. For example, where an assessment object 302 is an electric motor, one dependent intrinsic characteristic 308 might be the maximum horsepower of the electric motor. The electric motor will have well-understood horsepower values for different models and for different kinds of electric motors in the market on any date. As another example, where someone is estimating financial benefits of offering a product for sale in the competitive market, another potential dependent intrinsic characteristic 308 would be the expected revenue for the next five years the expected revenue is a more complex characteristic that can depend on various factors such as the kind of good or service being offered, the current size of the market in sales volume, the expected take rate by population of customers, estimates of market share each year, and the price value comparison of existing products.

Specific questions 310 can be provided that are designed to solicit information from respondents for the purpose of determining a value of a characteristic. For example, in the case of the maximum horsepower of an electric motor object, we might ask the direct question: “What is the maximum horsepower output of the electric motor in a normal operating environment of −20 deg C. to 80 deg C?” The respondent can be prompted to provide a specific answer, and this answer can be provided as a specific quantitative value. Depending on the value of the answer, the advantage or risk of the answer with competitive products in the market can be assessed. A follow up question would be “does this product have a performance advantage in the market?” More complex questions such as “what is the estimated revenue for offering this product in the market, over a period of five years?” is much more complex, and a simple quantitative answer will be sufficient in some instances. Since there is much uncertainty for this answer due to the extrinsic operating context of a competitive market, additional analytical evidence can be requested. Questions can be defined for each independent intrinsic characteristic 304 and for each dependent intrinsic characteristic 308 to acquire sufficient information through their answers that enable additional insights about the status/impact of the assessment object 302 through the lens of this independent intrinsic characteristic 304 or dependent intrinsic characteristic 308.

Respondents can be prompted to provide answers 312 to questions 310. In some embodiments, various default answers can be presented to the respondent that the respondent can select from, and available default answers can be influenced by a variety of factors. Available default answers can be directly influenced by the question 310, the nature of the independent intrinsic characteristics 304, dependent intrinsic characteristic 308, and the extrinsic characteristics 306. For example, where the assessment object 302 is an electric motor and a question 310 is presented to ask for the maximum horsepower of the electric motor, the expected answer 312 will be a quantitative value with a unit of measurement in horsepower. Evidence 316 can be requested or required to support the answer 312. In the example with the electric motor, evidence 316 can be vendor operational test results or third party test results.

In another more complex example, a question 310 can be presented about expected revenues for an offering of an electric motor as a new product. For such a question 310, the respondent can be required to provide evidence 316 and a rationale 314 explaining how the evidence 316 supports the answer 312. Providing answers 312 alongside a rationale 314 and supporting evidence 316 can impact the trustworthiness of the answer 312 positively or negatively, and the impact of the rationale 314 can depend upon the substance of the rationale 314 and evidence 316 provided in support of the rationale 314.

The assessment theory model 300 can also require evidence 316 in support of answer 312 and/or supporting rationales 314. Requiring evidence 316 can aid in promoting high objectivity for an assessment 303. Evidence 316 can be in the form of test data, analysis, external relevant trustworthy supporting information, simulations, direct respondent feedback about the assessment object 302 in the environment context of that assessment operating environment 301. In general, obtaining more data results in higher trustworthiness as increased amounts of data result in a higher sample size. Various predefined types of evidence and rationales can be created and used in some implementations for the default answers to questions 310, and the evidence and rationales can further refine the certainty and trustworthy factors for scoring adjustments as previously described.

One purpose of the assessment theory model 300 is to make an assessment 303 of some assessment object 302 by asking questions to understand the nature of the effects of an independent intrinsic characteristic 304 of the assessment object 302 or to understand the effects of the relationship between an assessment object 302 and an extrinsic characteristic 306 of the environment context. An overall assessment could be the result of analysis of multiple assessments with different respondents providing data. In some embodiments, individuals with various roles in an organization would respond to questions by providing answers, rationale, and evidence commensurate with their role in the organization. Another approach that could be taken is to assign the assessment to multiple individuals, for the purpose of statistically analyzing those assessment results to discover response commonality of significance criteria, i.e., those having higher agreement.

In the decision logic 320, logical inferences and analysis are defined in such a manner that they can interpret the results the assessment theory model 300. The first requirement for a valid decision is that the assessment 303 captures all the necessary information. Minimally necessary conditions can be designed into the logic of the assessment theory model 300. The decision logic 320 itself can also be represented as an ontology with its own concepts and necessary information requirements for a valid logical inference of some decision. The decision logic 320 will reference a subset of the assessment model theory concepts, relationships, and asserted data instances relevant to the logical inferences for that kind of decision. The decision logic 320 can utilize Bayesian techniques in some embodiments, but other approaches can be utilized as well. Assessment decisions can utilize the adjusted weights of category scoring and/or question scoring.

A decision 322 can be output for a specific decision logic 320. The decision logic 320 interprets a subset of the data for an assessment object 302. In one example embodiment of the universal assessment, a default value for a decision 322 can be “NotSatisfied” so that the assessment does not support a positive decision. The decision logic 320 can assert its interpretation of a portion of the assessment and its inference results to the decision class by asserting a relationship from the decision logic 320 results class to a “Satisfied” or “NotSatisfied” value in the decision class. Many different decisions can be supported by multiple decision logics, and the decisions can all interpret various subsets of the assessment model data. In some embodiments, a top level decision can be made as well as other lower level decisions, and the top level decision could logically integrate all or most of the lower level decisions to ultimately make an overall assessment of the object considering all relevant contexts and characteristics. In some embodiments, the decision 322 can be a persevere, pivot, or perish decision for a business opportunity. Where this is the case, there can be different decision classes for persevere, pivot, and perish. However, other decisions can be made such as a build or buy decision, a decision on whether or not to acquire or invest in a business, etc.

The decision logic interprets the facts asserted for each assessment and the scoring associated with each response in a specific assessment according to the predefined scoring module 200 of FIG. 2. This interpretation can be used to form a combined semantic and quantitative model that enables a deep understanding of the details of the assessment score for each intrinsic and extrinsic characteristic and their effects on the decision 322. The semantic representation defined by the assessment theory model 300 provides a contextual meaning that decision makers can understand. Additionally, the scoring module 200 of FIG. 2 provides an objective scoring approach that can be interpreted by the decision logic 320 of FIG. 3.

In the illustrated assessment theory model 300 of FIG. 3, various axioms are illustrated by arrows. In some embodiments, each of these axioms can be provided as necessary inquiries in the assessment theory model 300 to ensure that the specific assessment theory is valid. The logical axioms of the assessment theory model 300 can define the conditions of satisfaction that are required for an instance of an assessment concept to be considered a member of a concept class. The conditions typically define a necessary relationship between one concept instance of one concept (e.g. an independent intrinsic characteristic of an assessment object) to a necessary existence of another concept instance (e.g. a dependent intrinsic characteristic of an assessment object). In this way the axioms described here define the overall set of concept instances necessary for an assessment theory model 300 having improved accuracy in decisions.

For the first axiom (AX1), the assessment object 302 is evaluated to see whether the assessment object 302 has an independent intrinsic characteristics 304, and an asserted property “hasIndependentIntrinsicCharacteristic” can be provided to an instance of the independent intrinsic characteristic class where an independent intrinsic characteristic 304 is present. An assessment object 302 can have a plurality of independent intrinsic characteristics 304.

For the second axiom (AX2), the assessment object 302 is evaluated to see whether the assessment object 302 has any dependent intrinsic characteristics 308. The dependent intrinsic characteristic 308 is dependent upon some extrinsic characteristic 306 of the environmental context. An assessment object 302 can have a plurality of dependent intrinsic characteristics 308.

For the third axiom (AX3) through the fifth (AX5) axiom, the relationship between independent intrinsic characteristics 304 and dependent intrinsic characteristics 308 are analyzed. For the third axiom (AX3), the effect of an independent intrinsic characteristic 304 on a dependent intrinsic characteristic 308 is analyzed. Where the independent intrinsic characteristic 304 does in fact affect a dependent intrinsic characteristic 308, the independent intrinsic characteristic 304 in question can have the property “affectsIC.” For the fourth axiom (AX4), the effect of a dependent intrinsic characteristic 308 on an independent intrinsic characteristic 304 is analyzed. The dependent intrinsic characteristic 308 in question can have the property “affectsIC” where this is the case. Where an independent intrinsic characteristic 304 is impacted by another characteristic, it can be appropriate to reclassify the independent intrinsic characteristic 304 as a dependent intrinsic characteristic 308. For the fifth axiom (AX5), a dependent intrinsic characteristic 308 must not also be classified as an independent intrinsic characteristic 304 and vice versa.

The causal relationships AX3 and AX4 defined between intrinsic characteristics can vary in complexity and can vary based on the environment. In some embodiments, these causal relationships AX3 and AX4 can be predefined. However, in other embodiments, these causal relationships AX3 and AX4 can be discovered by subsequent analysis, and the specific assessment theory ontology can be updated based on the discovered causal relationships.

For the sixth axiom (AX6), the effect of one independent intrinsic characteristic 304 on another independent intrinsic characteristic 304 is analyzed. For example, where an intrinsic characteristic is a temporary intrinsic characteristic that might change over time, other intrinsic characteristics can impact that temporary intrinsic characteristic. For example, the age or gender of an organism can impact the weight of that organism.

For the seventh axiom (AX7), the effect of one dependent intrinsic characteristic 308 on another dependent intrinsic characteristic 308 is analyzed. For example, the expected revenue for a company in a calendar year can affect the expected profits and the expected market share for the company.

For the eighth axiom (AX8), an assessment is made of the assessment object 302. In some cases, the assessment must assess a dependent intrinsic characteristic or an independent intrinsic characteristic of the assessment object.

For the ninth axiom (AX9), an assessment is made of the assessment operation environment 301.

For the tenth axiom (AX10), the decision logic must analyze the results of the assessment 303. The eleventh axiom (AX11) can analyze whether sufficient information is present to make a decision 322.

For the twelfth axiom (AX12), potential questions are developed to help evaluate certain dependent intrinsic characteristics 308 of an assessment object 302. Furthermore, potential questions are developed for the thirteenth axiom (AX13) to help evaluate certain independent intrinsic characteristics 304 of the assessment object 302.

For the fourteenth axiom (AX14), potential answer 312 are obtained for given questions 310. The answer 312 can be default answers that are prepared in advance for each question.

For the fifteenth axiom (AX15), the rationale 314 provided in support of any answer 312 is analyzed, and, for the sixteenth axiom (AX16), the evidence 316 provided in support of the answer 312 and/or the rationale 314 is analyzed.

In some embodiments, ISO 56000:2020 innovation management principles and other principles from the ISO series on innovation management can be utilized in the assessment theory model 300. The assessment theory model 300 will ideally add value to the organization, challenge the strategy and objectives of the organization, motivate and mobilize for organizational development, be timely and focused on the future, allow for consideration of context, promote the adoption of best practice, be flexible and holistic, and be an effective and reliable process.

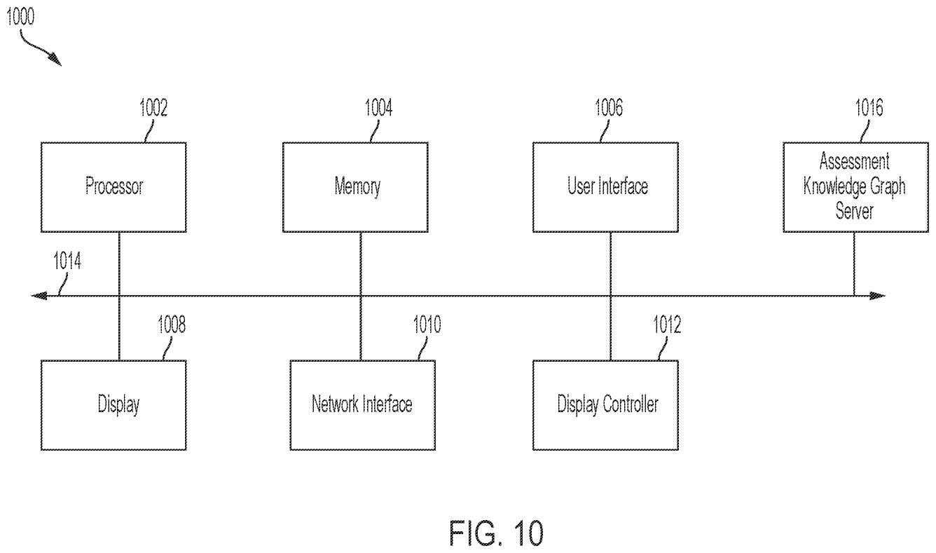

The various functions described herein can be logically described as being performed by one or more modules of the processing circuitry 1000 (see FIG. 10). It will be appreciated that such modules can be implemented in hardware, software, or a combination thereof. It will further be appreciated that, when implemented in software, modules can be part of a single program or one or more separate programs, and can be implemented in a variety of contexts (e.g., as part of an operating system, a device driver, a standalone application, and/or combinations thereof). In addition, software embodying one or more modules can be stored as an executable program on one or more non-transitory computer-readable storage mediums. Functions disclosed herein as being performed by a particular module can also be performed by any other module or combination of modules.

If definitions and relationships provided are consistent with the assessment theory model 300 and satisfy the required axioms, then the specific assessment model will be valid semantically and logically. This validity is focused on the validity of the assessment model and associated ontologies representing the semantics and necessary conditions of the ontologies.

Using the assessment theory model 300, incremental assessments can be made that improve the accuracy of the decisions at different phases of the assessment. There can be a defined sequence of assessment states or phases with specific intrinsic and extrinsic characteristics selected that are relevant for that phase, as well as activated questions for each characteristic or category relevant to that phase. The same category can be relevant for more than one phase of the assessment journey with specific questions associated with that characteristic defined for that phase. Incremental assessments can be beneficial in situations where not all information is readily available for an assessment. As more and more information is obtained through the incremental assessments, the understanding of the assessment object and the environmental context can evolve, and questions can be modified or substituted to obtain necessary information for making specific decisions. This enables the decision logic 320 to provide not only scores for each category but also for each phase. The decision logic 320 also has the capability to define different approaches to combine scores from the characteristics for each phase. In one exemplary approach, a decision classification is made at each phase as more information is gathered by the questions and answers.

The assessment theory model 300 can be used to represent knowledge provided by respondents in various roles at a specific point in time, and this can be similar to how a balance sheet represents the financial state of a company at some point in time. A specific population can be asked to respond to the assessment, and subsequent aggregate analysis can be used to create sample population statistical data from which insights for judgement about the assessment object 302 can be made.

Additionally, the assessment theory model 300 can be used to specify or select different subsets of the assessment model assessment criteria for information collection and classification of different sequential states along a path of an assessment journey. Distinct decision gates can be provided at different points of an assessment, and the decision logic can be executed against the evidence collected for assessment criteria since the last decision gate. Based on the decision made at the decision gates, the assessment can be continued or the assessment can cease.

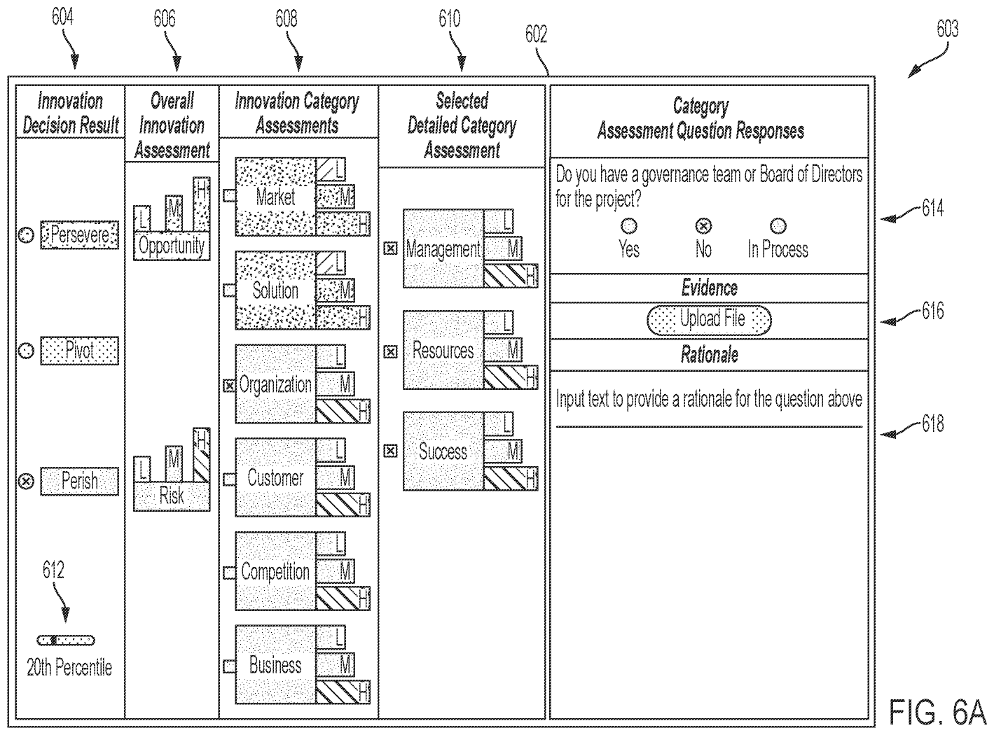

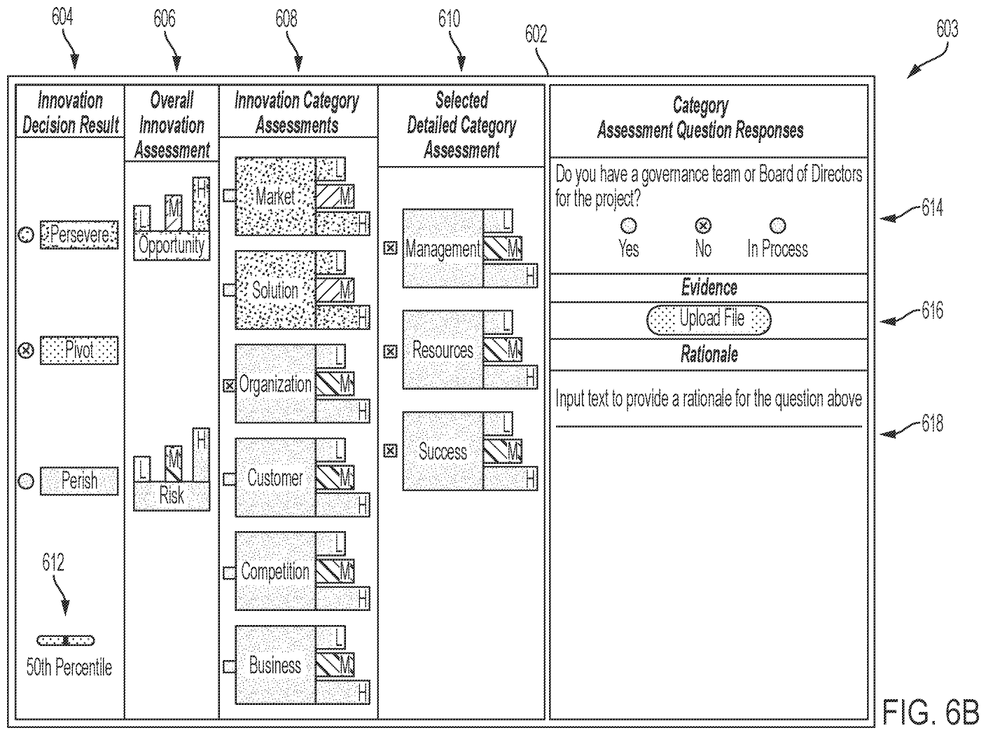

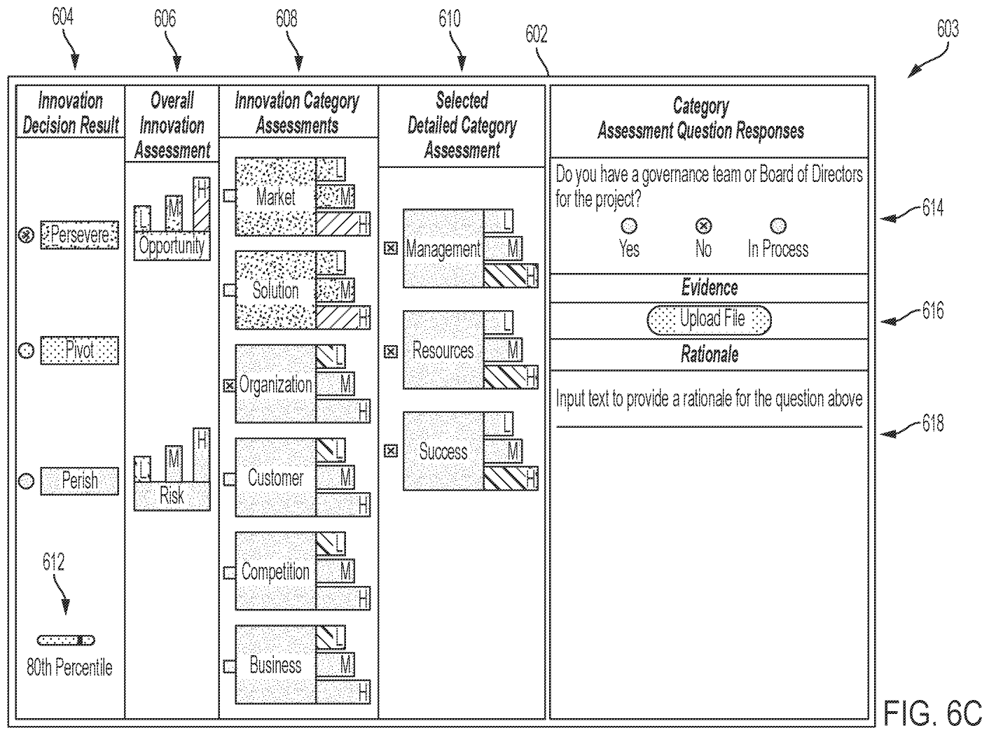

FIG. 4 is a schematic diagram illustrating exemplary modules that can be included in processing circuitry 1000 (see FIG. 10). A user interface module 402 can be provided. This user interface module 402 can receive inputs from a respondent, and the user interface module 402 can also present information to the respondent or provide prompts with questions to the respondent. For example, the user interface module 402 can be responsible for presenting screens illustrated in FIGS. 6A-6C. The user interface module 402 can be configured to receive input data from one or more sensors for example, the user interface module 402 can be configured to receive input data from a respondent from sensors associated with the display, from input buttons, from a microphone, from a joystick, or from some other sensor.

As noted in reference to FIG. 2, various modules can be provided within the scoring module 404 that are related to specific aspects of scoring determinations. A base scoring module 202 is provided that provides a base score for each response. Furthermore, the scoring module 200 can also include other modules therein to assist in assessing factors that impact scoring. These modules include an importance module 204 that assesses the importance of a given response, a trustworthiness module 206 that analyzes the trustworthiness of a given response, and a certainty module 208 that makes adjustments based on the level of uncertainty associated with a given response. A weighted scoring module 210 is also provided that provides a weighted score based on a base score provided at the base scoring module and based on outputs of the importance module 204, the trustworthiness module 206, and the certainty module 208.

An inquiry module 406 can be included that can craft various questions that are prompted to the respondent. The inquiry module 406 can craft questions that are geared towards obtaining information regarding characteristics (e.g. intrinsic characteristics) of an assessment object as well as extrinsic characteristics of the environment context, and the inquiry module 406 can also present questions related to other features. The inquiry module 406 can incrementally craft more refined questions on certain issues as answers, evidence, and supporting rationales are provided in order to provide more accurate decisions. In other embodiments, the inquiry module 406 can beneficially permit the respondent to respond to questions in the respondent's desired order. Doing so can be beneficial as it can permit the respondent to select respond to certain questions that the respondent considers to be important first, allowing additional questions to be crafted based on these initial responses. Furthermore, the respondent can deselect certain questions that are not relevant, and a respondent can respond to those questions that are relevant. In some embodiments, questions are provided to the respondent in a specified order, and the respondent can be required to respond to each of the questions sequentially.

As the questions from the inquiry module 406 are responded to by the respondent, the inquiry module 406 can develop additional questions to obtain details regarding important features of an assessment object, and the inquiry module 406 can cause these additional questions to be presented to the respondent. By forming and presenting these additional questions, the processing circuitry 1000 (see FIG. 10) can be configured to make incremental assessments with improved accuracy, and the questions being asked can evolve and improve based on the already received responses. Incremental assessments can be particularly beneficial in situations where not all information is readily available at the initial stage of an assessment. As more and more information is obtained through the incremental assessments, the understanding of the assessment object and the environmental context can evolve, and questions can be modified or substituted to obtain necessary information for making specific decisions. Incremental assessments can enable greater contextual focus on specific areas based on the responses, reduce the time required to complete assessments in some embodiments, and provide assessments that are more tailored to the particular assessment object and environmental context.

An external data module 408 can be included that can obtain data from external sources for use in assessments. In one exemplary approach, the external data module 408 can be used to provide evidence, and this evidence can be evaluated by a responder for selecting an answer. The external data can be discovered to be relevant to an intrinsic characteristic, and the external data can then be subsequently classified as relevant to a specific question associated with that characteristic. In some embodiments, the external data module 408 can be beneficially seek information from non-biased sources. The external data module 408 can be used to obtain various types of information, including but not limited to trends for venture capital investment and client early adopters. By obtaining the data from external sources, the external data from these external sources can be used to assist in determining which survey categories should have more relevance in any assessment, which can occur due to the scoring module 200 for having evidence for answers. The external data module 408 can obtain relevant external data based on the environmental context and/or the assessment object that is being assessed. In some cases, the initial data input by the respondent can be weighted less and given less consideration than other external data, but the relative weighting of initial data inputs and/or other external data can be different in other embodiments. External data can be obtained from non-biased sources such as the American Productivity & Quality Center (APQC), the ISO series on innovation management (e.g. ISO 56000:2020 innovation management principles), Eurostat Community Innovation Surveys (CISs), the Wharton Mack Institute for Innovation Management, and/or the American Society for Quality (ASQ). However, external data can be obtained from other sources. In some embodiments, data can be obtained from other sources that can be prone to bias; algorithms, artificial intelligence, and/or machine learning can be used to identify and account for the biases in the data.

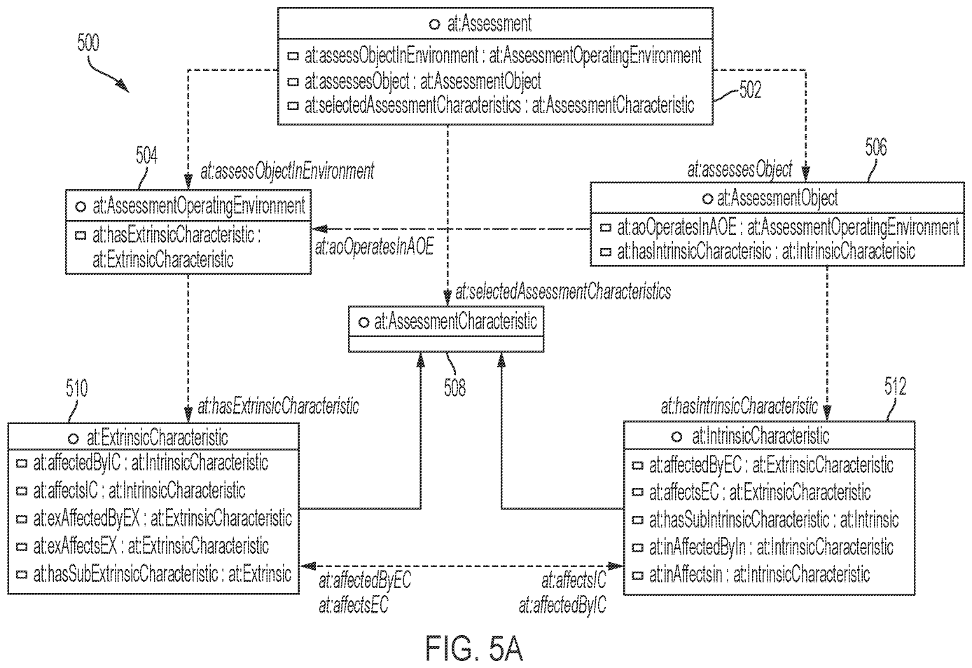

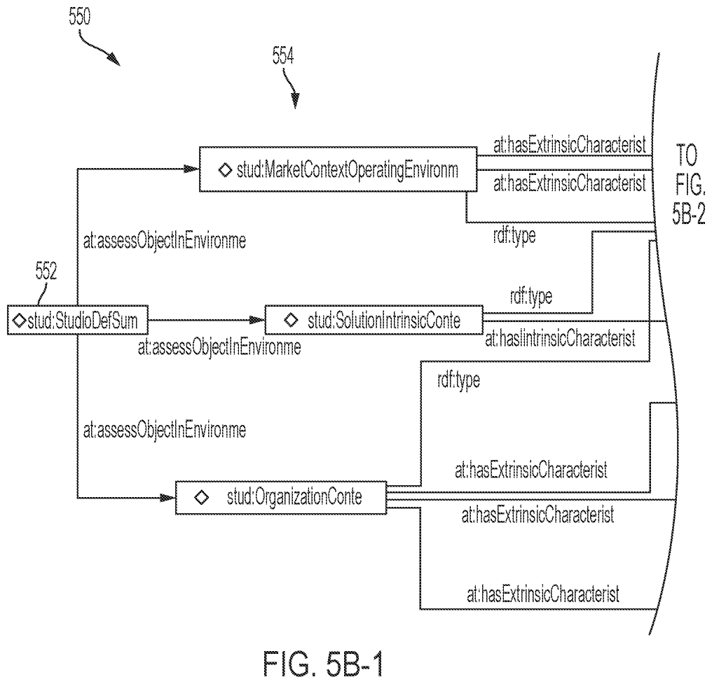

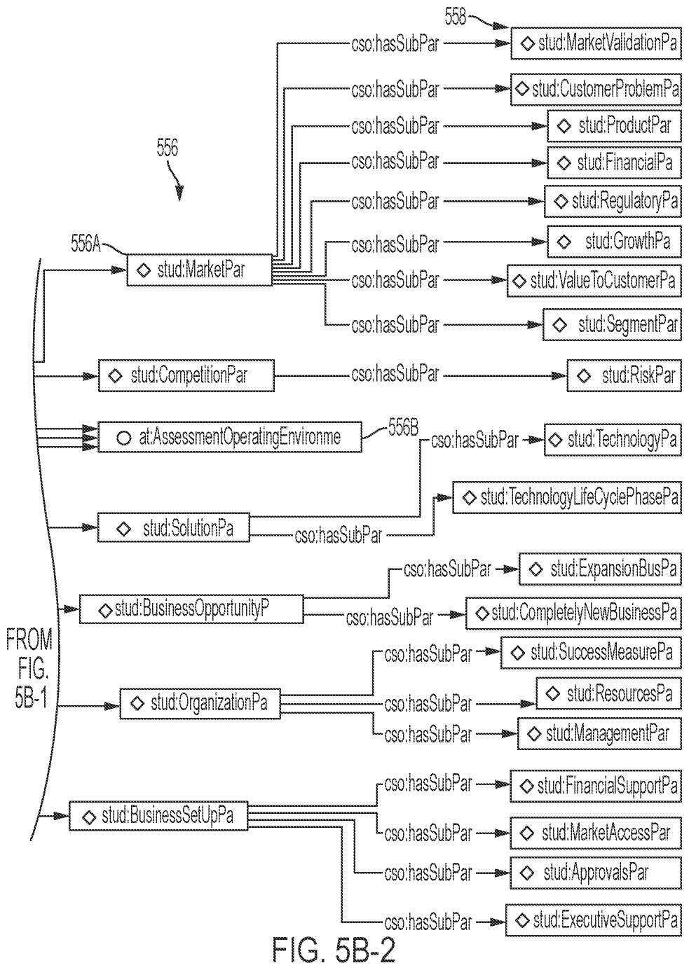

A relationship module 410 can be provided that evaluates relationships between the assessment object and its environment context. The relationship module 410 can identify relationships between an independent intrinsic characteristic of an assessment object and a dependent intrinsic characteristic of an assessment object, between one dependent intrinsic characteristic and another dependent intrinsic characteristic, and between an extrinsic characteristic and a dependent intrinsic characteristic. As more and more questions are responded to and as more data is obtained, the understanding of the relationships between various characteristics can be altered. For example, as more questions are responded to, it can become clearer that a strong relationship exists between one extrinsic characteristic of the environment context and another characteristic of an assessment object. The relationship module 410 can continuously or periodically evaluate the relationships between various characteristics to identify whether there is a strong relationship between characteristics, a weak relationship between characteristics, or no relationship between the characteristics. The strength of relationships can be provided in a quantitative manner in some embodiments. Additionally, the relationship module 410 can help in developing ontologies and forming ontology class diagrams similar to those illustrated in FIGS. 5A and 5B.

A decision module 412 can be provided that utilizes a developed ontology and evaluates input data, external data, and any other available data to make a decision. The decision module 412 can determine final innovation decision results such as persevere, pivot, perish determinations, and the decision module 412 can also be responsible for determining other final innovation decision results such as whether to build a new product internally or buy it from a third-party manufacturer, whether it is advisable to attempt to acquire or invest in another business, and to make other determinations. The decision module 412 can also be responsible for making intermediate level conclusions such as the opportunity and/or risk for a particular assessment object, and the decision module 412 can even be responsible for making lower level determinations such as the risk associated with lack of resources and/or a lack of customers.

A classification module 414 can be provided that organizes data points into various data types such as intrinsic characteristic data, extrinsic characteristic data, and other data types. The classification module 414 can be configured to organize the data based on the relevant context and the assessment object that is being assessed. For example, in some situations, the maximum performance or maximum capacity of an object can be appropriately considered to be an independent intrinsic characteristic and can be appropriately considered to be a dependent intrinsic characteristic in other examples. The maximum performance or maximum capacity of an object, the maximum number of respondents for a service offering, or the maximum number of data elements that can be stored in a database server can be appropriately considered to be an independent intrinsic characteristic in some instances. In these examples, the independent intrinsic characteristic 304 is permanent in specifying a maximum performance capacity that is realized when the object performs its function, and the independent intrinsic characteristic is not subject to change based on changes in the environment context. However, in other instances, the maximum realizable performance can be dependent on other extrinsic characteristics of the environment context, and the maximum realizable performance can be appropriately related to as a dependent intrinsic characteristic 308. For example, an electric motor can be configured to operate in an operating temperature range, so the maximum horsepower output can be dependent upon the operating temperature, with the operating temperature being an extrinsic characteristic. In such an instance, the maximum horsepower output can be considered to be a dependent intrinsic characteristic 308. The classification module 414 can work in conjunction with the relationship module 410. As relationships are identified or as it is determined that no relationship exists between characteristics, the classification module 414 can adjust the classification of various characteristics as an independent intrinsic characteristic 304, extrinsic characteristic 306, or a dependent intrinsic characteristic 308.

An improvement module 416 can be provided that assesses potential tasks that can be taken to improve ratings. For example, the improvement module 416 can analyze potential responses that are of high importance and inform the respondent to take a second look at the responses to those questions. Furthermore, the improvement module 416 can identify questions of high importance where the respondent provided minimal supporting evidence and rationales, and the improvement module 416 can prompt the respondent to consider providing further support for those questions. In some embodiments, the improvement module 416 can analyze the difficulty of completing various tasks to direct respondents to impactful tasks that are easier to complete. For example, where a start-up company is being assessed, the improvement module 416 can provide suggestions for reducing risk and/or improving opportunities e.g., the improvement module 416 can suggest changes in company type (e.g. sole proprietorship to LLC), to obtain critical documents, to hire certain personnel having appropriate qualifications, etc. As another example, the improvement module 416 can identify various responses which have a factors with a low score and can indicate to the respondent certain actions that can be taken to improve the factor for example, the improvement module 416 can identify a response having a low certainty factor or a low trustworthiness factor, and the improvement module 416 can make a suggestion to the respondent to provide further evidence in support of the response. The improvement module 416 can beneficially increase the relevant scoring for a certain assessment to potentially improve the final decision to an improved category (e.g. moving from the perish category to the pivot category or moving from the pivot category to the persevere category).

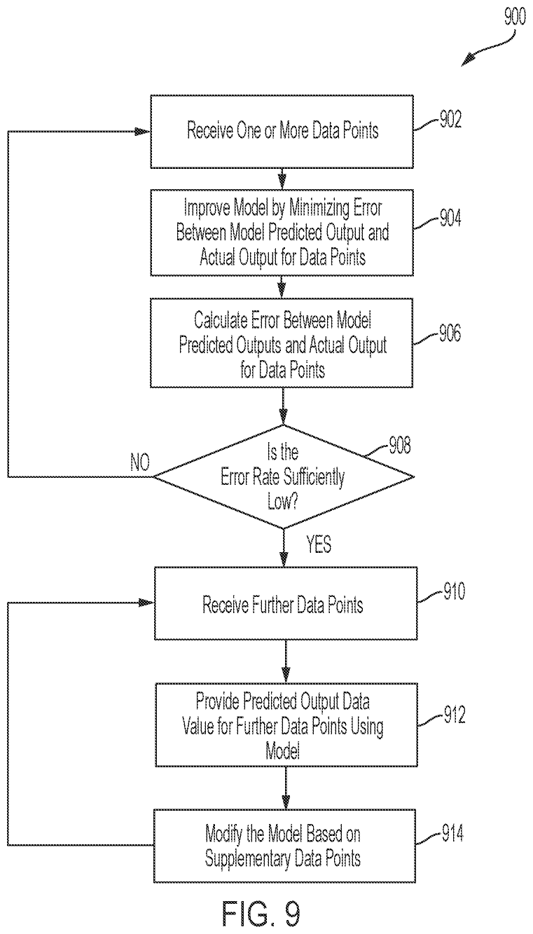

A machine learning module 418 can be provided that uses machine learning to help carry out various tasks. In some embodiments, the machine learning module 418 can be configured to execute the method 900 illustrated in FIG. 9. Machine learning can also be used in other respects. For example, machine learning can be used to assist in scoring, determining the trustworthiness of responses, identifying biases in one or more responses, to generate inquiries or select among potential inquiries, to identify relationships between various characteristics of an assessment object and/or an environmental context, to make classifications for characteristics of an assessment object and/or an environmental context, to generate potential improvements, or to make decisions. Machine learning can analyze data using the semantics of the assessment theory model 300 (see FIG. 2) and/or scoring model 200 (see FIG. 2) to formulate improvements, relationships, classifications, and decisions.

An assessment knowledge module 420 can be provided that can serve as the primary module for storing all the ontologies and assessment data consistent with W3C ontology languages (e.g., OWL/rdf). Additionally or alternatively, a knowledge base query module 422 can be provided having characteristics similar to the knowledge base query module 108 of FIG. 1. The assessment knowledge module 420 can support the W3C SPARWL query language that the knowledge base query module 422 defines and executes to gather the relevant assessment result information and to update the assessment models and scoring models.

While various modules are discussed herein, it should be understood that a variety of other modules can be provided in addition to the listed modules. Additionally, some of the modules that are illustrated in FIG. 4 and described herein are not provided in some embodiments, and the functionality of multiple modules can be combined together in other embodiments. The modules can be used to perform different tasks in other embodiments as well.

FIG. 5A is a schematic diagram illustrating an example assessment theory ontology class diagram 500 with associations between different characteristics. Various classes are presented in the diagram 500, including an assessment class 502, an assessment object environment class 504, an assessment object class 506, an assessment characteristic class 508, an extrinsic characteristic class 510, and an intrinsic characteristic class 512. Each class can have relationships with other classes, and these relationships are listed for the different classes. For example, the assessment class 502 has a relationship with the assessment object 506, with the assessment 502 identifying the given assessment object 506. In the assessment class 502, “at:assessesObject: at:AssessmentObject” can be provided as a result of this relationship.

Using the example assessment theory ontology class diagram 500, the ontology model can represent defined relationships that are used in the logic for the definitions of various axioms to define a valid assessment. In other words, when an assessment is defined, the axioms of described in the discussion of FIG. 3 can help identify what instances must be present as members of a specific class (e.g., in the independent intrinsic characteristic class 304) and what relationship object property assertions have to be made between various classes, and this can help realize a valid assessment theory semantic and logical model. FIG. 5A illustrates an example of a relatively simple ontology class diagram 500, but other ontology class diagrams 500 that can have increased complexity as more and more relationships are identified, the complexity of the ontologies can increase. Furthermore, ontologies can be made more complex where multiple dependent intrinsic characteristics, multiple independent intrinsic characteristics, and multiple extrinsic characteristics are considered.

FIG. 5B is another schematic diagram illustrating another example assessment theory ontology class diagram 550 with associations between different characteristics. In the illustrated ontology class diagram 550 of FIG. 5B, the various characteristics and other items are organized in different categories. On the left, the defined innovation assessment 552 is provided. Furthermore, main parameters 554, primary assessment characteristics 556, and sub-assessment characteristics 558 are also illustrated. Connections are illustrated between various sub-assessment characteristics 558 with one or more primary assessment characteristics 556 to indicate the presence of a relationship between the two. Furthermore, connections are illustrated between the primary assessment characteristics 556 and the main parameters 554 to indicate a relationship between the two, and connections are illustrated between the main parameters 554 and the defined innovation assessment 552 in order to indicate a relationship between the two. In the illustrated embodiment, the main parameters 554 include the market operation context, the solution operation context, and the organization operation context, but other parameters can be included as main parameters in other embodiments. Furthermore, in the illustrated embodiment of FIG. 5B, the primary assessment characteristics include the market, competition, the operating environment for the assessment, the business opportunities, the organization, and the set up for the business. Additionally, various sub-assessment characteristics 558 can be represented such as the customer problem, market validation, financial data, regulatory data, growth, risk, financial support, market access, etc. However, a wide variety of other parameters and characteristics can be considered.

As illustrated, some of the parameters and characteristics have relationships with multiple other parameters and/or characteristics. For example, the top primary assessment characteristic 556A related to the market in question has relationships with eight different sub-assessment characteristics 558, and the top primary assessment characteristic 556A has only one relationship with a main parameter 554 (the market operation context). As another example, the assessment operating environment primary assessment characteristic 556B has a relationship with all three of the main parameters 554.

Additional detail can be provided to the ontology class diagram 550 in other embodiments. For example, the ontology class diagram 550 can add more detailed items such as individual characteristics, and relationships can be represented between the individual characteristics and the other parameters and characteristics represented in the ontology class diagram 550 of FIG. 5B.

In some embodiments, the ontology class diagrams 500, 550 can be modified to indicate the strength of relationships between different parameters and characteristics. For example, the strength of relationships can be indicated by adding another ontology property that defines weight values according to the scoring module 200 for questions associated with subassessment characteristics 558. This has been done in an ontology representing the scoring module 200. However, the strength can be indicated in other ways as well. However, in some embodiments, the ontology class diagrams 500, 550 can be presented to the respondent on a display or to the assessment designers for the purpose of defining the assessment characteristics relevant to the kind of assessment context.

FIG. 6A-6C are schematic views illustrating example windows or screens 603 defined for a user interface 402 that can be generated by a user interface generator and presented on a display 602. In some embodiments, the assessment theory model 300 can be utilized to make a determination as to whether a company should persevere, pivot, or perish with their business proposal. The exemplary screens 603 provided in FIGS. 6A-6C are provided where a persevere, pivot, or perish determination is being made.

Looking first at the screen 603 presented in FIG. 6A, a perish recommendation is provided. The screen 603 can be presented in a display 602 to the respondent. In the innovation decision result pane 604 on the left side of the screen 603, information can be provided to indicate that the ultimate decision 322 (see FIG. 3) is to perish.

In some embodiments, a percentile rating 612 for the business proposal can be presented in the screen 603. In the illustrated embodiment, this percentile rating 612 is provided in the innovation decision result pane 604, but the percentile rating 612 can be provided at another location on the screen 603. In FIG. 6A, the percentile rating 612 provides an overall percentile rating for the business proposal based on the scoring for the business proposal, with the presented business proposal having a percentile rating 612 being in the 20^{th} percentile. However, in other embodiments, the percentile rating 612 can provide the percentile of the business proposal within its respective scoring group (e.g., 60^{th} percentile in the perish group). The percentile scoring can be different based on variations in the granularity of the scoring, the overall assessment, the decision classification, the category, and/or the question.

In the overall innovation assessment pane 606, a high level summary is provided of the opportunity and the risk for the given business proposal. In the illustrated overall innovation assessment pane 606, a simple indication is provided as to whether the opportunity for the business opportunity is a low-level opportunity, a medium-level opportunity, or a high-level opportunity, and a simple indication is also provided as to whether the risk for the business opportunity is a low-level risk, a medium-level risk, or a high-level risk. This approach can be beneficial to present complex information to the respondent and/or other users in a simple and easy-to-understand manner. In other embodiments, the information provided regarding the opportunity and risk can be presented in other ways. For example, rather than simply indicating that the risk or opportunity is low, medium, or high, a numerical score can be provided, a percentile score can be provided similar to the overall percentile rating 612, or additional quantitative categories can be provided (e.g. very low, low, medium, high, very high). In the overall innovation assessment pane 606 of FIG. 6A, an indication is provided that the opportunity is low and that the risk is high. In another exemplary embodiment, the overall summary provides only the total assessment score and its location within the range of the specific decision result (e.g., −50 within a Perish range of −100 to 0).

In the innovation category assessments pane 608, more detailed metric information can be provided. For example, with respect to metric information related to the opportunity associated with a business opportunity, market and solution metrics can be provided. Furthermore, with respect to metric information related to risk associated with a business opportunity, organization, customer, competition, and business metrics can be provided. Furthermore, in the selected detailed category assessment pane 610, additional metric information can be provided related to the risk or opportunity associated with the given business opportunity. In the illustrated embodiment, the selected detailed category metrics are related to the management, resources, and success of the business opportunity, but other detailed category metrics can be selected. In the illustrated embodiment of FIG. 6A, the market and solution metrics are both low and the risk metrics for organization, customers, competition, and business are each high in the innovation category assessments pane 608. Furthermore, in the illustrated embodiment of FIG. 6A, the risk metrics for management, resources, and success are each high. Given the poor results for the metrics provided in the overall innovation assessment pane 606, the innovation category assessments pane 608, and the selected detailed category assessment pane 610, the innovation decision result pane indicates that a perish innovation decision has bene made, and a poor percentile score in the 20^{th} percentile is provided. Metric information presented in the various panes can take into account just one independent intrinsic characteristic 304 (see FIG. 3), extrinsic characteristic 306 (see FIG. 3), or just one dependent intrinsic characteristic 308 (see FIG. 3), but metric information can instead be compiled based on multiple characteristics.

Various screens can be presented in the display to show the respondent's response to a question relevant to the selected detailed category, which in this diagram is the question about management. For example, the question pane 614 can present one or more questions 310 (see FIG. 3) provided by the respondent alongside selected answers 312 (see FIG. 3). In the illustrated embodiment of FIGS. 6A-6C, the answers 312 are the default answers selected by the respondent in an assessment. Default answers can be provided to limit the potential number of answers and to simplify processing of answers. In the illustrated embodiment, the question presented asks whether the business has a governance team or a Board of Directors for its business, and the default answers are yes, no, or in process and the respondent selected no. However, other questions can be presented, and other default answers can be provided in some situations (e.g., answer to indicate that question is not applicable to the business). In another embodiment, the user can modify the answer for the selected category, detailed category and question to observe its effect on the category scores and the overall decision result. This capability for user feedback provides “What if?” scenarios where it is possible to have different answers with more available information or with changes to the assessment object.

While the default answers are provided in FIGS. 6A-6C as select qualitative answers, respondents can instead be prompted to provide quantitative answers in some situations where it is appropriate to do so based on the question. For example, in evaluating a business, various questions can seek quantifiable metrics such as spending on research and development, number of personnel devoted to various aspects of the business, number of intellectual property filings, number of research projects in active development, percentage of products being made internally versus being made by external manufacturers, available budgets, time to market for ideas, sales from new products over past three years, revenue, customer satisfaction rates, etc. However, various other questions can be asked to seek other quantifiable metrics.

An evidence pane 616 and a rationale pane 618 can also be presented. For the result scenario, the evidence pane 616 can display the content of the evidence information or provide a link to access an appropriate file. In some embodiments, a “what if?” feedback could be provided to enable an operator to explore the effects of additional or alternative evidence and rationales on the scores. The evidence pane 616 can permit the respondent to upload a file to provide evidence 316 (see FIG. 3) to support the answer, and the rationale pane 618 can permit the respondent to input text to provide a rationale 314 (see FIG. 3) for the provided answer. Any evidence or rationales provided in support of the answer or the lack of any evidence or rationales in support of the answer can be considered in determining the trustworthiness of the answer, and this can have an effect on the question's score impact due to the factor adjustments for evidence and rationale. While the various panes are presented in the manner illustrated in FIG. 6A, additional panes can be provided and/or some of the panes can be omitted in other embodiments. Furthermore, the panes can be rearranged or sized differently in other embodiments. For example, the question pane 614 can be increased in size so that multiple questions can be presented to the respondent at one time so that the respondent can select which question the respondent would like to respond to first.

FIG. 6B illustrates another example of the screen presented on the display 602 where the innovation decision is to pivot. In this example, the percentile rating is in the 50^{th} percentile, and the various risk metrics and opportunity metrics are each in the medium range. However, in other examples, a pivot determination can be provided even where various risk and opportunity metrics are provided in the low or high ranges. FIG. 6C illustrates another example of the screen presented on the display 602 where the innovation decision is to persevere. In this example, the percentile rating is in the 80^{th} percentile, and the various risk metrics are each in the low range while the various opportunity metrics are each in the high range. However, in other examples, a persevere determination can be provided even where the various risk metrics fall in the medium or high range and where various opportunity metrics fall in the medium or low range.

The screens illustrated in FIGS. 6A-6C are merely exemplary, and the screens can be modified in other embodiments. For example, in one embodiment, three different scoring ranges were defined for Perish, Pivot and Persevere, and the aggregation of the category scores from the aggregation of their question/response score for a specific phase are displayed rather than a high, medium, and low score. This can effectively simplify the logic for summarizing the scores to a simple one of weighted scoring with multiple scoring definitions possible. The information presented in the screens can be modified where the relevant determinations are different (e.g. where a build or buy determination is being made). The information presented can also be different based on differences in the environment context and/or the assessment object. While the various panes are all provided in a single screen 603 in FIGS. 6A-6C, some of the panes can be provided in different screens in other embodiments.

The universal assessment system enables the creation of multiple assessment theory models 300 to support decisions 322 resulting from an assessment 303. Any universal assessment model 303 can be created from a fixed set of concepts defined in FIG. 3 (e.g., assessment 303, assessment object 302, assessment environment and its extrinsic characteristics 306, etc.).

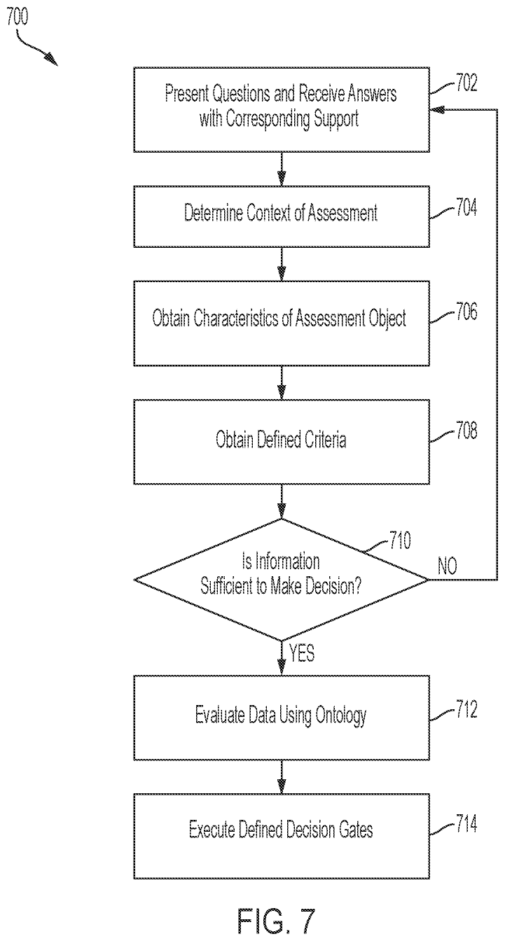

Various methods of making universal assessments are also contemplated. FIG. 7 is a flow chart illustrating one such example method 700. The method 700 is beneficial in that it can be adapted for making a wide variety of determinations and to assess a wide variety of assessment objects. Notably, the operations of FIG. 7 can be performed in various orders, and the operations need not proceed in the order specified in FIG. 7.

At operation 702, questions are presented to the respondent, and respondents are prompted to provide an answer. The answer can be in the form of a default answer in some embodiments, and this can be beneficial where the answer is a qualitative one. However, the respondent can be prompted to provide a quantitative answer by inserting a numerical value where it is appropriate to do so for the particular question. Respondents can be prompted to provide answers alongside corresponding evidence and rationales for some or all of the questions. Questions can be developed using the inquiry module 406 (see FIG. 4), and the respondent can be prompted to address the questions.

At operation 704, the environment context of the assessment is determined. The object qualities are obtained at operation 706, and the defined criteria are obtained at operation 708. In some embodiments, the understanding of the environment context can be improved by obtaining information from external sources. For example, where an assessment is being made regarding the acquisition of a potential business, external data can be obtained regarding other competitors, the products of competitors, and profits, revenue, and market share information of the business and its competitors. Based on the determination of the environment context of the assessment, the universal assessment can be refined.

Characteristics of an assessment object can be determined as more answers are provided by the respondent and as evidence and supporting rationales are provided by the respondent. Furthermore, the defined criteria can be presented in the form of questions and default answers for the respondent, and the respondent can be prompted to present evidence in support of their answer as well as a rationale in support of the answer. The defined criteria can provide guidance as to the relevant evidence and rationale that the respondent can provide.

At operation 710, a determination is made as to whether the data that is present is sufficient to make an ultimate decision for the assessment. If the data is not sufficient, the method 700 will proceed back to operation 702 and proceed through the operations again for further refinement. If the data is sufficient to make a decision, then the method 700 will proceed to operation 712. In other embodiments, the determination 710 can be provided at other positions in the method 700. In most cases, the data will not be sufficient to make a determination for several iterations of the initial operations for the method 700, and these initial operations can be performed several times until the data has been refined a sufficient amount to provide an accurate decision. As more information is obtained regarding the environment context, the assessment object and its characteristics, and the defined criteria, further questions can be presented based on the improved understanding of the environment context and/or the assessment object. Data is evaluated using an ontology at operation 712, and defined decision gates can be executed at operation at operation 714.

Operations can be performed in any order, and operations can be performed simultaneously in some embodiments. Additional operations can be performed in other embodiments, and some of the operations illustrated in FIG. 7 can be omitted in other embodiments. While the method 700 shows an iterative loop occurring only when the information is not sufficient to make a decision as determined at operation 710, the method 700 can be performed iteratively based on requests to do so from the respondent or as further data is received.

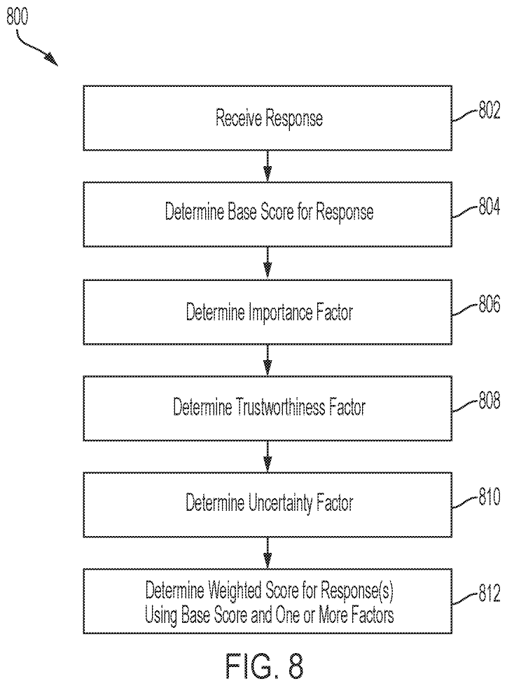

Methods are also contemplated for scoring. FIG. 8 is a flow chart illustrating an example method 800 for scoring responses. In some embodiments, the method 800 can be executed by the scoring module 404 (see FIG. 4), but the method 800 can be executed by other components or modules in other embodiments. The respondent can be prompted to respond to certain questions to elicit a response from the respondent. At operation 802, the response is received, and the response will include an answer. The response can also include a rationale provided by the respondent to support the answer, and the response can also include evidence provided by the respondent to support the answer and/or the rationale. In some embodiments, the response will simply include the answer, and the answer can be in the form of a default answer. The answer can also be in the form of a quantitative answer where the question calls for some numerical value.

At operation 804, a base score for the response is determined. The scoring module 404 (see FIG. 4) can be configured to provide various scoring adjustments based on the answers, evidence, and rationales provided by the respondent. For each responses, a score ranging from −5 to +5, a score ranging from −5 to 0, or a score ranging from 0 to +5 can be provided, with the relevant scoring range being provided based on questions asked. For example, where a question is directed towards risks for a given assessment object, then the score range of −5 to 0 will likely be appropriate, and where a question is directed towards the opportunities provided by an assessment object, then the score range of 0 to +5 will likely be appropriate.

At operation 806, an importance factor can be determined for the response. The scoring module 404 (see FIG. 4) can include an importance factor that can be dependent upon the importance of certain questions and/or responses. This importance factor can, for example, be an integer weighed from 1 to 10. Increasing the importance factor of one response will effectively reduce the importance factor of another response.

At operation 808, a trustworthiness factor can be determined. The trustworthiness factor can adjust the score associated with a particular question downwardly where the answers, evidence, and/or rationales provided in response to the question are inconsistent with answers, evidence, and/or rationales provided in response to another question. The trustworthiness factor can also adjust the score associated with a particular question downwardly where answers, evidence, and/or rationales indicate some bias in how the respondent is responding to the questions. Where responses are consistent and/or there is no bias detected, the trustworthiness factor can adjust the score associated with a particular question upwardly in some embodiments.

At operation 810, a certainty factor can be determined. The determination can be weaker where there is inherent uncertainty regarding some aspects of the assessment, and the use of the certainty factor can be beneficial to account for this. Where limited information is available regarding a certain question, a certainty factor can be reduced to effectively adjust the score downwardly for the given question. In some embodiments, where the information available for a certain characteristic of an assessment object is high, the certainty factor can actually be increased so that the score is improved due to the increased certainty. In some embodiments, the limited information can be based on the lack of supporting evidence and/or supporting rationales.

At operation 812, the weighted score for one or more responses can be determined. This can be done by taking into account the base score and one or more of the factors 806, 808, 810. In some embodiments, the base score and the various factors being used (e.g. the importance factor, the trustworthiness factor, the certainty factor) can be multiplied together to get a weighted score for the question and response. In some embodiments, a cross-product can be used to get the cumulative impact of the various responses. Through the scoring approach taken by the scoring module 404 (see FIG. 4), an objective score can be obtained to provide increased accuracy in assessments.

FIG. 9 is a flow chart illustrating an example method 900 of machine learning that can be executed at a machine learning module and that can be utilized in making universal assessments. This method of machine learning can be utilized with artificial intelligence in some embodiments. At least one processor or another suitable device can be configured to develop a model for conducting universal assessments, such as described herein in various embodiments. In some embodiments, processing circuitry 1000 (see FIG. 10) can comprise one or more processors that perform the functions shown in FIG. 9.

This system can beneficially make universal assessments by accounting for various types of data, intrinsic characteristics of assessment objects, extrinsic characteristics, assessment characteristics, etc. Further, the developed model can assign different weights to different types of data and/or characteristics that are provided. In some systems, even after the model is deployed, the systems can beneficially improve the developed model by analyzing further data points. By utilizing artificial intelligence and/or machine learning, a novice user can benefit from the experience of the models utilized, and different relationships can be identified that a novice user or even experienced users would fail to identify. Embodiments beneficially allow for accurate assessments to be provided and allow for information about these assessments to be shared with the user (such as on the display) so that the user can make well-informed decisions. Utilization of the model can prevent the need for a user to spend a significant amount of time conducting assessments, freeing the user to perform other tasks and enabling performance and consideration of complex estimations and computations that the user could not otherwise solve on their own (e.g., the systems described herein can also be beneficial for even the most experienced users). Additionally, the use of artificial intelligence and/or machine learning can help eliminate bias that can otherwise be present models can be generated by finding relationships between different data points and characteristics, and these models can be created without the need for any initial input from a person, which can be prone to bias.

By receiving several different types of data, the example method 900 can be performed to generate complex models. The example method 900 can find relationships between different types of data that are not anticipated. By detecting relationships between different types of data, the method 900 can generate accurate models even where a limited amount of data is available.

In some embodiments, the model can be continuously improved even after the model has been deployed. Thus, the model can be continuously refined based on changes over time, which provides a benefit as compared with other models that stay the same after being deployed. The example method 900 can also refine the deployed model to fine-tune weights that are provided to various types of data based on subtle changes. For example, as the economic environment changes over time, continuous refinement over time can be helpful to ensure that any model that is developed remains effective. By contrast, where a model is not continuously refined, subsequent changes can make the model inaccurate until a new model can be developed and implemented, and implementation of a new model can be very costly, time-consuming, and less accurate than a continuously refined model.

At operation 902, one or more data points are received. These data points can be the initial data points being received, but other data points can be the initial data points that are received in some embodiments. The data points received at operation 902 preferably comprise known data on a characteristic that the model can be used to evaluate. For example, where the model is being generated to evaluate a characteristic of a certain assessment object, the data points provided at operation 902 will preferably comprise known data that corresponds to that characteristic. The data points provided at operation 902 will preferably be historical data points with verified values to ensure that the model generated will be accurate. The data points can take the form of discrete data points. However, where the data points are not known at a high confidence level, a calculated data value can be provided, and, in some cases, a standard deviation or uncertainty value can also be provided to assist in determining the weight to be provided to the data value in generating a model.

The model can be formed based on historical comparisons of a historical characteristics with historical data for other similar assessment objects, and a processor can be configured to utilize the developed model to determine an estimated characteristic properties. This model can be developed through machine learning utilizing artificial intelligence based on the historical comparisons of the historical characteristics with other historical data for similar assessment objects. Alternatively, a model can be developed through artificial intelligence, and the model can be formed based on historical comparisons of historical characteristics with other historical data for similar assessment objects. A processor can be configured to use the model and input data into the model to determine the one or more characteristics.

At operation 904, a model is improved by minimizing error between a predicted outputs and/or estimated outputs generated by the model. In some embodiments, an initial model can be provided or selected by a user. The user can provide a hypothesis for an initial model, and the method 900 can improve the initial model. However, in other embodiments, the user will not provide an initial model, and the method 900 can develop the initial model at operation 904, such as during the first iteration of the method 900. The process of minimizing error can be similar to a linear regression analysis on a larger scale where three or more different variables are being analyzed, and various weights can be provided for the variables to develop a model with the highest accuracy possible. Where a certain variable has a high correlation with the actual characteristic, that variable can be given increased weight in the model. For example, where the availability of a certain material at low pricing has a strong impact on the profitability of the potential product, this variable the price of the material can be given increased weight in a model used to determine whether or not to bring that product to market. In refining the model by minimizing the error between the predicted object characteristic and/or object-type generated by the model and the actual characteristics, the component performing the method 900 can perform a very large number of complex computations. Sufficient refinement results in an accurate model.

In some embodiments, the accuracy of the model can be checked. For example, at operation 906, the accuracy of the model is determined. This can be done by calculating the error between the model predicted outputs and the actual outputs. In some embodiments, error can also be calculated before operation 904. By calculating the accuracy or the error, the method 900 can determine if the model needs to be refined further or if the model is ready to be deployed. Where the characteristic is a qualitative value or a categorical value such as a yes or no answer, a business type, or some other qualitative value, the accuracy can be assessed based on the number of times the predicted value was correct. Where the characteristic is a quantitative value, the accuracy can be assessed based on the difference between the actual value and the predicted value. However, other approaches for determining accuracy can also be used.

At operation 908, a determination is made as to whether the calculated error is sufficiently low. If the error rate is not sufficiently low, then the method 900 can proceed back to operation 902 so that one or more additional data points can be received. If the error rate is sufficiently low, then the method 900 proceeds to operation 910. Once the error rate is sufficiently low, the training phase for developing the model can be completed, and the implementation phase can begin where the model can be used to predict the expected outputs.

By completing operations 902, 904, 906, and 908, a model can be refined through machine learning utilizing artificial intelligence. Notably, example model generation and/or refinement can be accomplished even if the order of these operations is changed, if some operations are removed, or if other operations are added.

During the implementation phase, the model can be utilized to provide a determined output. An example implementation of a model is illustrated from operations 910-912. In some embodiments, the model can be modified (e.g., further refined) based on the received data points, such as at operation 914.

At operation 910, further data points are received. For these further data points, the relevant output and its properties are not known in some instances. At operation 912, the model can be used to provide a predicted output data value for the further data points. Thus, the model can be utilized to determine the output.

At operation 914, the model can be modified based on supplementary data points, such as those received during operation 910 and/or other data points. By providing supplementary data points, the model can continuously be improved even after the model has been deployed. The supplementary data points can be the further data points received at operation 910, or the supplementary data points can be provided to the processor from some other source. In some embodiments, the processor(s) or other components performing the method 900 can receive external data from external sources and verify the further data points received at operation 910 using this external data. By doing this, the method 900 can prevent errors in the further data points from negatively impacting the accuracy of the model.

In some embodiments, supplementary data points are provided to the processor(s) from some other source and are utilized to improve the model. For example, supplementary data points can be saved to a memory 1004 (see FIG. 10) associated with processor 1002 (see FIG. 10), and supplementary data points can be transferred to memory 1004 from the communication bus 1014 (see FIG. 10), the network interface 1010 (see FIG. 10), and/or the user interface 1006 (see FIG. 10). In some embodiments, the supplementary data points can be transferred via the network interface 1010 from a remote device. In some embodiments, supplementary data points can be verified before being provided to the processor 1002 to improve the model, or the processor 1002 can verify the supplementary data points before utilizing the supplementary data points.

As indicated above, in some embodiments, operation 914 is not performed and the method proceeds from operation 912 back to operation 910. In other embodiments, operation 914 occurs before operation 912 or simultaneous with operation 912. Upon completion, the method 900 can return to operation 910 and proceed on to the subsequent operations. Supplementary data points can be the further data points received at operation 910 or some other data points.

FIG. 10 illustrates one exemplary architecture of the processing circuitry 1000. In other embodiments, the processing circuitry 1000 can differ in architecture and operation from that shown and described here.

The illustrated processing circuitry 1000 includes a processor 1002 which can be configured to execute various operations discussed here. However, the processor 1002 can be used to execute various functions described herein. The processor 1002 can operate using an operating system (OS), device drivers, application programs, and so forth. The processor 1002 can include any type of microprocessor or central processing unit (CPU), including programmable general-purpose or special-purpose microprocessors and/or any one of a variety of proprietary or commercially-available single or multi-processor systems.

The processing circuitry 1000 can also include a memory 1004, which provides temporary or permanent storage for code to be executed by the processor 1002 or for data that is processed by the processor 1002. The memory 1004 can include read-only memory (ROM), flash memory, one or more varieties of random access memory (RAM), and/or a combination of memory technologies. The memory 1004 can include any conventional medium for storing data in a non-volatile and/or non-transient manner. The memory 1004 can thus hold data and/or instructions in a persistent state (i.e., the value is retained despite interruption of power to the processing circuitry 1000). The memory 1004 can include one or more hard disk drives, flash drives, USB drives, optical drives, various media disks or cards, and/or any combination thereof and can be directly connected to the other components of the processing circuitry 1000 or remotely connected thereto, such as over a network.

The various elements of the processing circuitry 1000 are coupled to a bus system 1014. The illustrated bus system 1014 is an abstraction that represents any one or more separate physical buses, communication lines/interfaces, and/or multi-drop or point-to-point connections, connected by appropriate bridges, adapters, and/or controllers.

The exemplary processing circuitry 1000 also includes a user interface 1006, a display 1008, a network interface 1010, and a display controller 1012. The user interface 1006 can receive inputs from the user via touch commands that are detected on a display, based on inputs received at input keys, based on drawings or text written by a user, based on voice commands, and in other various ways. The display 1008 can present information to the user such as questions, current results of the assessment, other information about the assessment, etc. The network interface 1010 enables the processing circuitry 1000 to communicate with remote devices (e.g., digital data processing systems) over a network. The display controller 1012 can include a video processor and a video memory, and display controller 1012 can generate images to be displayed on one or more displays in accordance with instructions received from the processor 1002.

The assessment knowledge graph server 1016 can host all of the ontologies, defined assessment models, defined scoring models, and all data from each assessment response and subsequent analysis. This assessment knowledge graph server 1016 can be complaint with W3C OWL/rdf recommendations for ontology languages and the direct semantics for such languages as defined by W3C. The assessment knowledge graph server 1016 can also support W3C SPARQL ontology query language and other graph query languages.

In some embodiments, the architecture 1000 of FIG. 10 can be implemented on a Cloud system, whereby resources are allocated on demand. In such an architecture the essential need for similar resources are provided by a cloud resource environment, which act as the host computing resource environment for the universal assessment system.

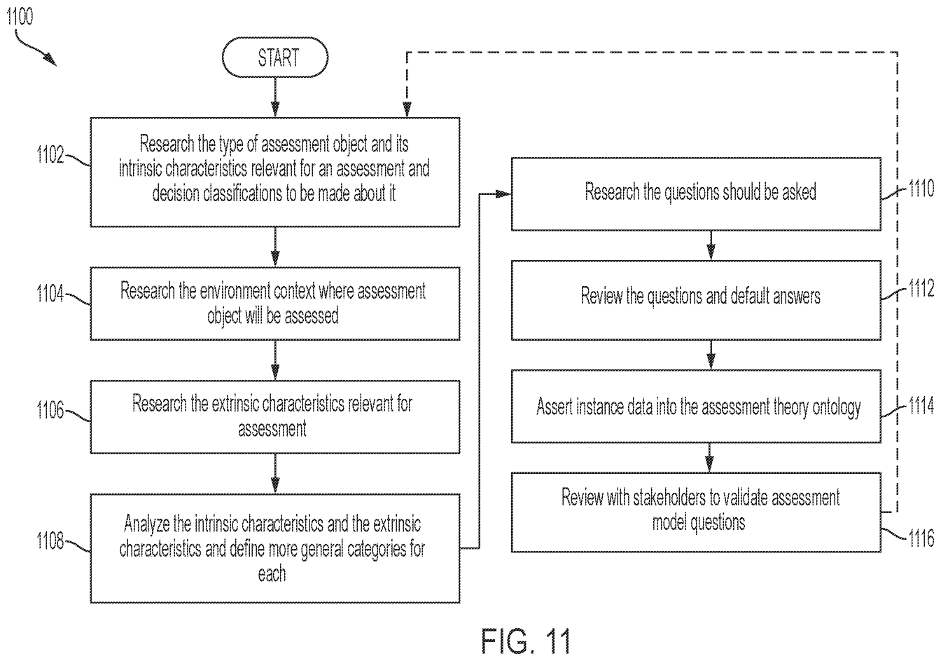

The flow chart of FIG. 11 describes one process for defining one instance of an assessment model.

At operation 1102, the type of assessment object and its intrinsic characteristics relevant for an assessment is researched, and the decision classifications to be made about it are also researched. Operation 1102 can be focused on gaining a good understanding of the object to be assessed 302, understanding the nature of the assessment 303 that will satisfy the kind of decisions 322 to be made, and then identifying and clarifying those intrinsic characteristics of the assessment object that with information about them would aid in the decision. Operation 1102 can also be focused on an understanding of these intrinsic characteristics how they would help in understanding their relationships to extrinsic characteristics.

At operation 1104, the environment context where the assessment object will be assessed is researched. Operation 1104 can be focused on identifying those environmental contexts in which the assessment object will be evaluated against. There can be more than one environmental context and the model theory can enable a separate assessment model to be defined for each environment context which by definition requires multiple assessment model definitions, or rather to combine multiple environment contexts in one assessment model definition. Both are supported by the assessment theory ontology 106A and questionnaire survey ontology 106B.

At operation 1106, the extrinsic characteristics relevant for assessment are researched. Operation 1106 identifies and defines the extrinsic characteristics that with information about them help understand the effect the assessment object has on them or vice-versa. Again the focus should be on not identifying these extrinsic characteristics in a vacuum, but rather identifying those extrinsic characteristics of the environment context that are influenced by or influence some intrinsic characteristics of the object that are relevant to the assessment focus and scope. In some embodiments, the understanding of the environment context can be improved by obtaining information from external sources. For example, where an assessment is being made regarding the acquisition of a potential business, external data can be obtained regarding other competitors, the products of competitors, and profits, revenue, and market share information of the business and its competitors. Based on the determination of the environment context of the assessment, the universal assessment can be refined.

At operation 1108, the intrinsic characteristics and the extrinsic characteristics are analyzed, and more general categories are defined for each of the assessment object characteristics.

At operation 1110, research can be done to identify questions that should be asked. This can be done to gain information about a specific assessment object for both intrinsic and extrinsic characteristics and define the possible set of default answers for each. Operation 1110 reviews the previous operations to ensure that the identified extrinsic and intrinsic characteristics cover the necessary information to make an assessment with an informed decision for the identified assessment object type.

At operation 1112, the questions and default answers are reviewed. This review can be performed to ensure that the questions and default answers provide the information necessary to the kinds of decisions for the assessment. Operation 1112 creates one or more questions 310 and answers 312 for each defined intrinsic and extrinsic characteristic. The questions can be formed in such a manner that they will have a finite set of possible answers. Questions can be of two types, those that are factual in nature and are not estimations or judgements, and those that are estimations or judgements that rely on experts or data analysis or estimation models.

At operation 1114, the ontologist asserts instance data into the assessment theory ontology 106A. This can be done by asserting the instance data in the form of rdf triples to create a new instance of an assessment model definition per exemplary classes and relations in FIG. 5A for the assessment, the assessment object, the assessment operating environment, the intrinsic characteristic (which can be independent or dependent), the extrinsic characteristic, the question, the answer, and the decisions. Operation 1114 involves creating the new assessment model instance by making data assertions or inputs to the assessment theory ontology 106A and the question survey ontology 106B. For one embodiment these are in fact rdf/owl triple assertions. An example of some of these assertions can be made using the ontology set of classes and properties as illustrated in FIG. 5A. Here are a few exemplary triples that define an assessment instance 502, and assessment environment and the relationship between them. In this example, a motor is being assessed in a manufacturing environment and an assessment model MotorAssessment has been defined as an instance of the ontology class at:Assessment, while an instance at:ManufacturingEnvironment has been defined as an instance of type at:AssessmentOperatingEnvironment. This at:MotorAssessment model instance is starting to form by now asserting a relationship at:assessObjectInEnvironment to the at:ManufacturingEnvironment. In such a manner, other instances and properties of the assessment model instance at:MotorAssessment are formed for the other classes: (i) at:MotorAssessment rdf:type at:Assessment; (ii) at:ManufacturingEnvironment rdf:type at:AssessmentOperatingEnvironment; (iii) at:MotorAssessment at:assessObjectInEnvironment at:ManufacturingEnvironment.

At operation 1116, material is reviewed with stakeholders to validate the assessment model questions. The next operation 1116 is focused on reviewing the defined assessment model with stakeholders and to make any final modifications. In some embodiments, the method 1100 can be performed iteratively so that additional refinement can occur following operation 1116. Where the method 1100 is performed iteratively, the method 1100 can proceed from operation 1116 back to operation 1102. However, some or all of the operations are performed in subsequent iterations in some embodiments.

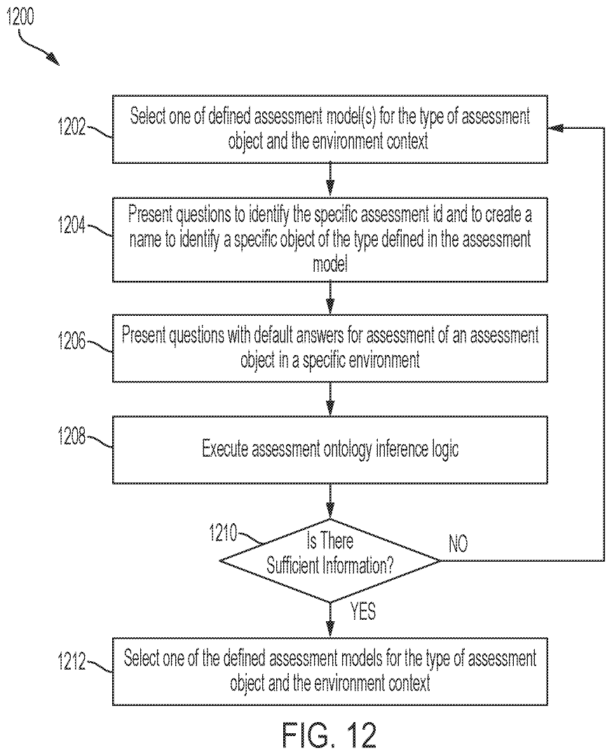

Various methods of making universal assessments are also contemplated. FIG. 12 is a flow chart illustrating one such example method1200 that involve use of the universal assessment system. The method 1200 is beneficial in that it can be adapted for making a wide variety of determinations and to assess a wide variety of assessment objects. Notably, the operations of FIG. 12 can be performed in various orders, and the operations need not proceed in the order specified in FIG. 12.

At operation 1202, a selection of one or more defined assessment models is made for the type of assessment object and the environment context for assessing the object. If no specific assessment model is available that satisfies the need, then another one can be created as specified in FIG. 11. In this case, it can prove beneficial to copy an existing assessment model and then modify it where it has related object types and environment contexts. This would minimize the need for the creation of entirely new extrinsic and intrinsic characteristics and their associated questions and answers.

At operation 1204, questions are presented to identify the specific assessment identification and to create a name to identify a specific object of the type defined in the assessment model. Specific new instances can be created for the assessment and the assessment object.

At operation 1206, questions are presented with default answers for assessment of an assessment object in a specific environment. Questions are presented to the respondent, and respondents are prompted to provide an answer. The answer can be in the form of a default answer in some embodiments, and this can be beneficial where the answer is a qualitative one. However, the respondent can be prompted to provide a quantitative answer by selecting a default range of quantitative values that are presented for selection. Respondents can be prompted to provide answers alongside corresponding evidence and rationales for some or all of the questions. Questions can be developed using the inquiry module 406 (see FIG. 4), and the respondent can be prompted to address the questions.

At operation 1208, the assessment ontology inference logic of the innovation assessment knowledge system 106 is executed. At operation 1210, a determination is made as to whether the data that is present is sufficient to make an ultimate decision for the assessment. If the data is not sufficient, the method will proceed back to operation 1202 and proceed through the operations again for further refinement. If the data is sufficient to make a decision, then the method 1200 will proceed to operation 1212. In most cases, the data will not be sufficient to make a determination for several iterations of the initial operations for the method 1200, and these initial operations can be performed several times until the data has been refined a sufficient amount to provide an accurate decision. As more information is obtained regarding the environment context, the assessment object and its characteristics, and the defined criteria, further questions can be presented based on the improved understanding of the environment context and/or the assessment object. Data is evaluated using an ontology queries at operation 1212, and results provide at multiple levels of granularity (e.g., decision gate phases, category characteristics, question level).

At operation 1212, one of the defined assessment models are selected for the type of assessment object and the environment context. At operation 1212, the knowledge base query module 108 can be executed with the effect of garnering the assessment results and populating the interface panes as illustrated in FIGS. 6A, 6B, and 6C in one embodiment. Operations can be performed in any order, and operations can be performed simultaneously in some embodiments. Additional operations can be performed in other embodiments, and some of the operations illustrated in FIG. 12 can be omitted in other embodiments. While the method 1200 shows an iterative loop occurring only when the information is not sufficient to make a decision as determined at operation 1210, the method 1200 can be performed iteratively based on requests to do so from the respondent or as further data is received.

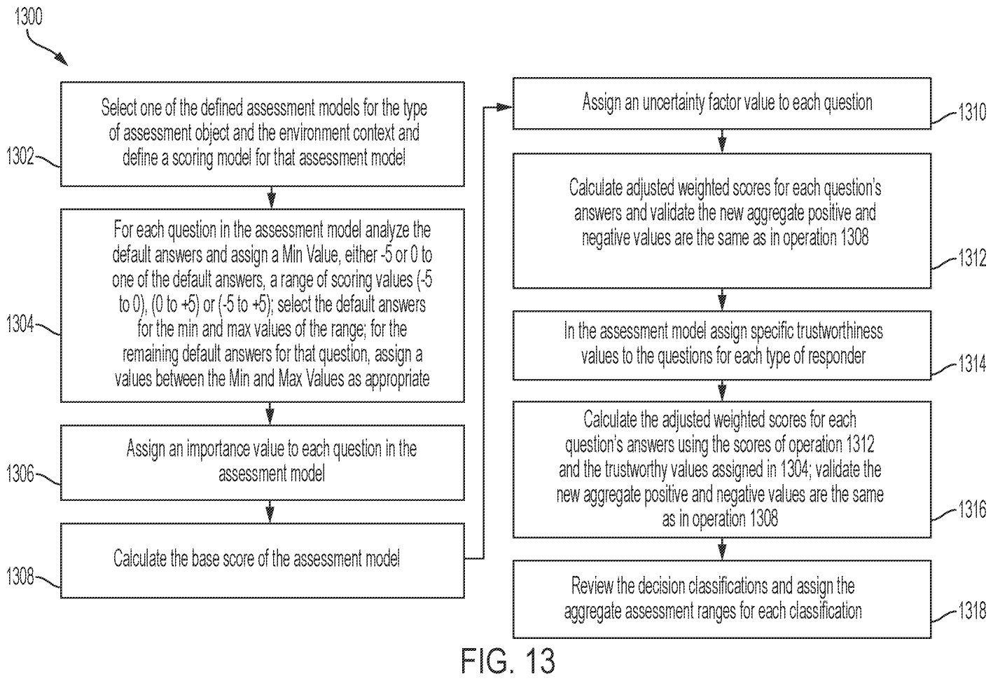

Other methods are also contemplated for scoring. FIG. 13 is a flow chart illustrating an example method 1300 for defining scoring models. In some embodiments, the method 1300 can be executed by the scoring module 404 (see FIG. 4), but the method 1300 can be executed by other components or modules in other embodiments. Since the respondent can be prompted to respond to certain questions to elicit a response from the respondent, it can be beneficial to start assigning scoring values to each question and its default answers as described below

At operation 1302, the specific assessment model is selected to have a new scoring model assigned to it and a scoring model is defined for that assessment model. Selection can be made based on the type of assessment object and based on the environment context. An assessment model can have more than one scoring model assigned to it for various interpretations from different perspectives. For example, a marketing department might decide to focus on extrinsic characteristics associated with competition, potent market penetration percentages, number of potential customers, with the effect of focusing the importance factor on these areas, but still considering other related characteristics. Though the assessment models typically can have multiple perspective focus based on the nature of the extrinsic and intrinsic characteristics, it is still possible to change the assessment model to focus on specific characteristics by having different scoring models for different perspectives. For instance, to remove the effects on a characteristics on the score it is only necessary to reduce its questions importance factor to 0. Following the process flow of 1300, a total perspective can be obtained across all characteristics. Alternatively, different perspectives can only consider one or more characteristics, decision gates, or phases.

At operation 1304, the possible range of score values is first decided for each question (e.g., −5 to 0, 0 to +5 or −5 to +5). Then an answer is selected for the Min value of the range and another answer is selected for the max value of the range. Other answers are assigned values between these Min and Max values of the range. The response answer can also include a rationale provided by the respondent to support the answer, and the response can also include evidence provided by the respondent to support the answer and/or the rationale. The existence of a rationale and/or evidence response to a question for an answer is accounted for in the scoring model by assigning an adjustment factor for each to the initial values already assigned for each case. Lack of rationale or evidence will assign a negative adjustment to lower the initial assignments defined here.

At operation 1306, an importance factor is assigned to each question in the context of the assessment perspective. As stated previously, if the characteristic or question is not in the perspective of this scoring model but exists in the assessment model, an importance factor of 0 can be assigned to the question. The question's scores than will have no impact on the assessment score. Care must be taken to consider the relative importance for each major characteristic category and for each decision phase or stage gate. If a question is unique to a stage gate, then its importance could be relative to other questions in that phase. Another approach considers importance from an overall assessment perspective and assigns importance to questions regardless of the phase or stage gate, but rather to an overall decision using information from all phases or where questions are repeated at later phases where new information is obtained. The ability to have multiple scoring models is apparent to enable this kind of flexibility of focus on scoring scope and perspective.

The scoring module 200 (see FIG. 2) can include an importance module 204 (see FIG. 2) that can determine an importance factor, and the importance factor can be dependent upon the importance of certain questions and/or responses. This importance factor can, for example, be an integer weighed from 1 to 10. Increasing the importance factor of one response will effectively reduce the importance factor of another response.

At operation 1308, a base score for the assessment scoring model is calculated. The scoring module 404 (see FIG. 4) can be configured to provide various scoring models based on the answers, evidence, and rationales defined for different perspectives of the assessment model according to the perspective of each stakeholder. The initial base score is calculated in one embodiment by first aggregating the positive scores and the negative scores to find the MinBaseRangeValue and the MaxBaseRangeValue of the assessment model across all questions having an importance value greater than 0. Then, for each question's answer, a new score value is calculated by calculating the weighted score value for each default answer by the modification of the importance value. Two other score values can also be assigned to this by modifying these by two other factors: nonexistence of rationale and nonexistence of evidence. New weighted score values are calculated by adjusting the importance score weighted scores for answers to create two additional scores as defined here. If either the rationale or evidence is presented in the response, then the initial weighted importance score value is used of an answer. If one or the other occurs, then the adjusted weighted score value is used for that answer.

At operation 1310, an uncertainty factor is assigned to each question. Initially in one embodiment the questions are categorized as two types: (i) factual and (ii) estimation or judgmental. The former uncertainty factor is such that no changes are made to the score values of the answers for the weighted scores in operation 1308. But if the question is estimation or judgmental one approach considers that the question's impact should lessen due to its uncertainty by some adjustment factor. In this case, all the answers to that question would be adjusted by the same factor. Typically an uncertainty factor for factual question would be “1”, and for an estimation or judgement question the uncertainty factor could be a value between 0.5 and 0.9. This later case has the effect of lowering the impact on the score of estimation or judgmental questions. The determination can be weaker where there is inherent uncertainty regarding some aspects of the assessment, and the use of the certainty factor can be beneficial to account for this. Where limited information is available regarding a certain question, an uncertainty factor can be reduced to effectively adjust the score downwardly for the given question. In some embodiments, where the information available for a certain characteristic of an assessment object is high, the uncertainty factor can actually be increased so that the score is improved due to the increased certainty. In some embodiments, the limited information can be based on the lack of supporting evidence and/or supporting rationales.

In operation 1312, an adjusted weighted score for all question's answers is calculated, and the Max and Min aggregate range values for all positive and negative questions are validated to ensure that they are the same as those calculated in operation 1308. An adjusted weighted score can be calculated using the base scores of operation 1308 and by considering the uncertainty factor values assigned in operation 1310. All the answers to a question can be adjusted by the same uncertainty factor as calculated in operation 1308. Then the weighted impact of each question's answers to the score can be calculated to create a new set of adjusted weighted scores considering the uncertainty factor.

In operation 1314, assign trustworthiness values to the questions based for each type of responder. The assignment of specific trustworthiness values can be done in the assessment model.

In operation 1316, adjusted weighted scores for each question's answers are calculated, and the Max and Min aggregate range values for all positive and negative questions are validated to ensure that they are the same as those calculated in operation 1308. The adjusted weighted scores can be obtained by using the adjusted weighted scores of 1312 and the responder type trustworthy factor.

In operation 1318, the decision classifications are reviewed and the aggregate assessment ranges for each classification can be assigned. At operation 1318, all the score assignments can be reviewed. Furthermore, at operation 1318, these values for the scoring model can be asserted in the assessment analysis ontology of the assessment analysis module 110 stored in the innovation assessment knowledge system 106.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

That which is claimed:

1. A system capable of making an assessment of an assessment object, the system comprising:
an inquiry module configured to generate a plurality of questions;
a user interface module configured to receive from a user responses to the plurality of questions;
a scoring module configured to generate a score based on the responses from the user; and
a decision module that generates the assessment based on the score and the responses.

2. The system of Claim 1, further comprising:
a relationship module configured to identify a causal relationship between an extrinsic characteristic of an environment context and an intrinsic characteristic of the assessment object,
wherein the decision module is configured to make the assessment based on the causal relationship.

3. The system of Claim 2, wherein the system is configured to determine one or more assessments of different assessment object types within one or more influencing environments, wherein the system has one or more defined assessment models defining sets of questions for a defined assessment object and extrinsic characteristics, with each defined assessment model of the one or more defined assessment models has one or more scoring models.

4. The system of Claim 3, wherein the inquiry module is configured to generate a refined question based on a previous response.

5. The system of Claim 4, wherein the scoring module comprises:
a base scoring module that is configured to generate a base score for at least one response of the responses;
one or more additional modules that are configured to provide one or more scoring adjustments to the base score for the at least one response; and
a weighted scoring module that generates the score for the at least one response based on the base score and the one or more scoring adjustments,
wherein the decision module makes the assessment based on the score.

6. The system of Claim 5, wherein the one or more additional modules includes an importance module, wherein the importance module is configured to provide an importance level scoring adjustment based on an importance level of the at least one response.

7. The system of Claim 6, wherein the one or more additional modules includes a trustworthiness module, wherein the trustworthiness module is configured to provide a trustworthiness scoring adjustment based on a trustworthiness of the at least one response, and wherein the trustworthiness scoring adjustment is impacted by at least one of a detected bias in the at least one response, consistency with an additional response, or inconsistency with the additional response.

8. The system of Claim 7, wherein the one or more additional modules includes a certainty module, and wherein the certainty module is configured to provide a certainty scoring adjustment based on an uncertainty level of the at least one response.

9. The system of Claim 8, wherein the at least one response includes an answer, a rationale in support of the answer, and evidence in support of at least one of the answer or the rationale, and wherein the one or more additional modules are configured to provide one or more scoring adjustments to the base score for the at least one response based on the rationale and the evidence.

10. The system of Claim 8, further comprising:
an assessment knowledge module for storing one or more ontologies;
a knowledge base query module that is configured to load material for use in the assessment; and
an extraction module that receives the responses and extracts relevant answers, rationales, and evidence from the responses.

11. The system of Claim 10, wherein the one or more ontologies include an assessment theory ontology, a question survey ontology, a journey ontology, a decision ontology, a decision gate ontology, and an assessment analysis ontology.

12. The system of Claim 11, wherein the system is configured to cause the presentation of questions on a display, and wherein the system is configured to present metric information with a final decision or an intermediate decision of the assessment.

13. The system of Claim 11, further comprising:
an improvement module that assesses a potential task that improves the score,
wherein the improvement module causes presentation of the potential task on a display.

14. A method for making an assessment of an assessment object, the method comprising:
receiving at least one response from a user;
determining a base score for the at least one response;
determining at least one scoring adjustment based on at least one additional factor;
determining a weighted score for the at least one response using the base score and the at least one scoring adjustment; and
making the assessment based on the weighted score.

15. The method of Claim 14, wherein the at least one scoring adjustment includes an importance level scoring adjustment based on an importance level of the response.

16. The method of Claim 15, wherein the at least one scoring adjustment includes a trustworthiness scoring adjustment based on a trustworthiness of the at least one response, wherein the trustworthiness scoring adjustment is impacted by at least one of a detected bias in the at least one response, consistency with an additional response, or inconsistency with the additional response.

17. The method of Claim 14, wherein the at least one scoring adjustment includes a certainty scoring adjustment based on an uncertainty level of the response.

18. A non-transitory computer readable medium having stored thereon software instructions that, when executed by a processor, cause the processor to:
receive at least one response;
determine a base score for the at least one response;
determine at least one scoring adjustment based on at least one additional factor;
determine a weighted score for the at least one response using the base score and the at least one scoring adjustment; and
make an assessment based on the weighted score.

19. The non-transitory computer readable medium of Claim 18, wherein the at least one scoring adjustment includes an importance level scoring adjustment based on an importance level of the response.

20. The non-transitory computer readable medium of Claim 18, wherein the at least one scoring adjustment includes a trustworthiness scoring adjustment based on a trustworthiness of the at least one response, wherein the trustworthiness scoring adjustment is impacted by at least one of a detected bias in the at least one response, consistency with an additional response, or inconsistency with the additional response.
